(19) United States
(12) Patent Application Publication
(10) Pub. No.: US 2007/0289818 A1
(43) Pub. Date: Dec. 20, 2007

(54) Expandable Tubular Lubrication

(75) Inventor: Charles Butterfield, Cypress, TX (US)

Correspondence Address: KING & SPALDING, LLP, 1100 LOUISIANA ST., STE. 4000, HOUSTON, TX, 77002-5213, US

(73) Assignee: Enventure Global Technology, Houston, TX (US)

(21) Appl. No.: 11/754,190

(22) Filed: May 25, 2007

Related U.S. Application Data
(63) Continuation-in-part of application No. 10/571,041, filed on Nov. 1, 2006.
(63) Continuation-in-part of application No. 10/784,679, filed on Feb. 23, 2004.

(51) Int. Cl. F01M 1/00; B29D 23/00; C09K 8/502; C10M 109/00; C10M 135/02

(52) U.S. Cl. 184/14; 428/34.1; 428/36.9; 507/100; 508/110; 508/181

(57) ABSTRACT

A lubrication for expandable tubulars.

### CROSS REFERENCE TO RELATED APPLICATIONS

This application claims the benefit of the filing date of PCT/US2005/043122 filed on Nov. 29, 2005, which claimed the benefit of the filing date of U.S. provisional patent application Ser. No. 60/631,703, attorney docket number 25791.326, filed on Nov. 30, 2004, the disclosure which is incorporated herein by reference. This application is also a continuation in part of U.S. non-provisional patent application Ser. No. 10/571,041 filed Sep. 7, 2004 and a continuation in part of U.S. non-provisional patent application Ser. No. 10/784,679 filed Feb. 23, 2004.

This application claims the benefit of the filing date of U.S. provisional patent application Ser. No. 60/600679, attorney docket number 25791.194, filed on Aug. 11, 2004, the disclosure, which is incorporated herein by reference. This application claims the benefit of the filing date of U.S. provisional patent application Ser. No. 60/585370, attorney docket number 25791.299, filed on Sep. 2, 2004, the disclosure, which is incorporated herein by reference. This application claims the benefit of the filing date of U.S. provisional patent application Ser. No. 60/500435, attorney docket number 25791.304, filed on Sep. 5, 2003, the disclosure, which is incorporated herein by reference. This application claims the benefit of the filing date of U.S. provisional patent application Ser. No. 60/500435, attorney docket number 25791.305, filed on Sep. 5, 2003, the disclosure which is incorporated herein by reference. This application claims the benefit of the filing date of U.S. provisional patent application Ser. No. 60/500435, attorney docket number 25791.306, filed on Sep. 2, 2003, the disclosure which is incorporated herein by reference. This application claims the benefit of the filing date of U.S. provisional patent application Ser. No. 60/500435, attorney docket number 25791.307, filed on Sep. 5, 2003, the disclosure which is incorporated herein by reference. This application claims the benefit of the filing date of U.S. provisional patent application Ser. No. 60/500435, attorney docket number 25791.308, filed on Sep. 5, 2003, the disclosure which is incorporated herein by reference. This application claims the benefit of the filing date of U.S. provisional patent application Ser. No. 60/598020, attorney docket number 25791.329, filed on Aug. 2, 2004, the disclosure, which is incorporated herein by reference. This application claims the benefit of the filing date of U.S. provisional patent application Ser. No. 60/601502, attorney docket number 25791.338, filed on Aug. 13, 2004, the disclosure, which is incorporated herein by reference.

This application is related to the following co-pending applications: (1) U.S. Pat. No. 6,497,289, which was filed as U.S. patent application Ser. No. 09/454,139, attorney docket no. 25791.03.02, filed on Dec. 3, 1999, which claims priority from provisional application 60/111,293, filed on Dec. 7, 1998, (2) U.S. patent application Ser. No. 09/510,913, attorney docket no. 25791.7.02, filed on Feb. 23, 2000, which claims priority from provisional application 60/121,702, filed on Feb. 25, 1999, (3) U.S. patent application Ser. No. 09/502,350, attorney docket no. 25791.8.02, filed on Feb. 10, 2000, which claims priority from provisional application 60/119,611, filed on Feb. 11, 1999, (4) U.S. Pat. No. 6,328,113, which was filed as U.S. patent application Ser. No. 09/440,338, attorney docket number 25791.9.02, filed on Nov. 15, 1999, which claims priority from provisional application 60/108,558, filed on Nov. 16, 1998, (5) U.S. patent application Ser. No. 10/169,434, attorney docket no. 25791.10.04, filed on Jul. 1, 2002, which claims priority from provisional application 60/183,546, filed on Feb. 18, 2000, (6) U.S. patent application Ser. No. 09/523,468, attorney docket no. 25791.11.02, filed on Mar. 10, 2000, which claims priority from provisional application 60/124,042, filed on Mar. 11, 1999, (7) U.S. Pat. No. 6,568,471, which was filed as patent application Ser. No. 09/512,895, attorney docket no. 25791.12.02, filed on Feb. 24, 2000, which claims priority from provisional application 60/121,841, filed on Feb. 26, 1999, (8) U.S. Pat. No. 6,575,240, which was filed as patent application Ser. No. 09/511,941, attorney docket no. 25791.16.02, filed on Feb. 24, 2000, which claims priority from provisional application 60/121,907, filed on Feb. 26, 1999, (9) U.S. Pat. No. 6,557,640, which was filed as patent application Ser. No. 09/588,946, attorney docket no. 25791.17.02, filed on Jun. 7, 2000, which claims priority from provisional application 60/137,998, filed on Jun. 7, 1999, (10) U.S. patent application Ser. No. 09/981,916, attorney docket no. 25791.18, filed on Oct. 18, 2001 as a continuation-in-part application of U.S. Pat. No. 6,328,113, which was filed as U.S. patent application Ser. No. 09/440,338, attorney docket number 25791.9.02, filed on Nov. 15, 1999, which claims priority from provisional application 60/108,558, filed on Nov. 16, 1998, (11) U.S. Pat. No. 6,604,763, which was filed as application Ser. No. 09/559,122, attorney docket no. 25791.23.02, filed on Apr. 26, 2000, which claims priority from provisional application 60/131,106, filed on Apr. 26, 1999, (12) U.S. patent application Ser. No. 10/030,593, attorney docket no. 25791.25.08, filed on Jan. 8, 2002, which claims priority from provisional application 60/146,203, filed on Jul. 29, 1999, (13) U.S. provisional patent application Ser. No. 60/143,039, attorney docket no. 25791.26, filed on Jul. 9, 1999, (14) U.S. patent application Ser. No. 10/111,982, attorney docket no. 25791.27.08, filed on Apr. 30, 2002, which claims priority from provisional patent application Ser. No. 60/162,671, attorney docket no. 25791.27, filed on Nov. 1, 1999, (15) U.S. provisional patent application Ser. No. 60/154,047, attorney docket no. 25791.29, filed on Sep. 16, 1999, (16) U.S. provisional patent application Ser. No. 60/438,828, attorney docket no. 25791.31, filed on Jan. 9, 2003, (17) U.S. Pat. No. 6,564,875, which was filed as application Ser. No. 09/679,907, attorney docket no.25791.34.02, on Oct. 5, 2000, which claims priority from provisional patent application Ser. No. 60/159,082, attorney docket no. 25791.34, filed on Oct. 12, 1999, (18) U.S. patent application Ser. No. 10/089,419, filed on Mar. 27, 2002, attorney docket no. 25791.36.03, which claims priority from provisional patent application Ser. No. 60/159,039, attorney docket no. 25791.36, filed on Oct. 12, 1999, (19) U.S. patent application Ser. No. 09/679,906, filed on Oct. 5, 2000, attorney docket no. 25791.37.02, which claims priority from provisional patent application Ser. No. 60/159,033, attorney docket no. 25791.37, filed on Oct. 12, 1999, (20) U.S. patent application Ser. No. 10/303,992, filed on Nov. 22, 2002, attorney docket no. 25791.38.07, which claims priority from provisional patent application Ser. No. 60/212,359, attorney docket no. 25791.38, filed on Jun. 19, 2000, (21) U.S. provisional patent application Ser. No. 60/165,228, attorney docket no. 25791.39, filed on Nov. 12, 1999, (22) U.S. provisional patent application Ser. No. 60/455,051, attorney docket no. 25791.40, filed on Mar. 14, 2003, (23) PCT application US02/2477, filed on Jun. 26, 2002, attorney docket no. 25791.44.02, which claims priority from U.S. provisional patent application Ser. No. 60/303,711, attorney docket no. 25791.44, filed on Jul. 6, 2001, (24) U.S. patent application Ser. No. 10/311,412, filed on Dec. 12, 2002, attorney docket no. 25791.45.07, which claims priority from provisional patent application Ser. No. 60/221,443, attorney docket no. 25791.45, filed on Jul. 28, 2000, (25) U.S. patent application Ser. No. 10/______, filed on Dec. 18, 2002, attorney docket no. 25791.46.07, which claims priority from provisional patent application Ser. No. 60/221,645, attorney docket no. 25791.46, filed on Jul. 28, 2000, (26) U.S. patent application Ser. No. 10/322,947, filed on Jan. 22, 2003, attorney docket no. 25791.47.03, which claims priority from provisional patent application Ser. No. 60/233,638, attorney docket no. 25791.47, filed on Sep. 18, 2000, (27) U.S. patent application Ser. No. 10/406,648, filed on Mar. 31, 2003, attorney docket no. 25791.48.06, which claims priority from provisional patent application Ser. No. 60/237,334, attorney docket no. 25791.48, filed on Oct. 2, 2000, (28) PCT application US02/04353, filed on Feb. 14, 2002, attorney docket no. 25791.50.02, which claims priority from U.S. provisional patent application Ser. No. 60/270,007, attorney docket no. 25791.50, filed on Feb. 20, 2001, (29) U.S. patent application Ser. No. 10/465,835, filed on Jun. 13, 2003, attorney docket no. 25791.51.06, which claims priority from provisional patent application Ser. No. 60/262,434, attorney docket no. 25791.51, filed on Jan. 17, 2001, (30) U.S. patent application Ser. No. 10/465,831, filed on Jun. 13, 2003, attorney docket no. 25791.52.06, which claims priority from U.S. provisional patent application Ser. No. 60/259,486, attorney docket no. 25791.52, filed on Jan. 3, 2001, (31) U.S. provisional patent application Ser. No. 60/452,303, filed on Mar. 5, 2003, attorney docket no. 25791.53, (32) U.S. Pat. No. 6,470,966, which was filed as patent application Ser. No. 09/850,093, filed on May 7, 2001, attorney docket no. 25791.55, as a divisional application of U.S. Pat. No. 6,497,289, which was filed as U.S. patent application Ser. No. 09/454,139, attorney docket no. 25791.03.02, filed on Dec. 3, 1999, which claims priority from provisional application 60/111,293, filed on Dec. 7, 1998, (33) U.S. Pat. No. 6,561,227, which was filed as patent application Ser. No. 09/852,026, filed on May 9, 2001, attorney docket no. 25791.56, as a divisional application of U.S. Pat. No. 6,497,289, which was filed as U.S. patent application Ser. No. 09/454,139, attorney docket no. 25791.03.02, filed on Dec. 3, 1999, which claims priority from provisional application 60/111,293, filed on Dec. 7, 1998, (34) U.S. patent application Ser. No. 09/852,027, filed on May 9, 2001, attorney docket no. 25791.57, as a divisional application of U.S. Pat. No. 6,497,289, which was filed as U.S. patent application Ser. No. 09/454,139, attorney docket no. 25791.03.02, filed on Dec. 3, 1999, which claims priority from provisional application 60/111,293, filed on Dec. 7, 1998, (35) PCT Application US02/25608, attorney docket no. 25791.58.02, filed on Aug. 13, 2002, which claims priority from provisional application 60/318,021, filed on Sep. 7, 2001, attorney docket no. 25791.58, (36) PCT Application US02/24399, attorney docket no. 25791.59.02, filed on Aug. 1, 2002, which claims priority from U.S. provisional patent application Ser. No. 60/313,453, attorney docket no. 25791.59, filed on Aug. 20, 2001, (37) PCT Application US02/29856, attorney docket no. 25791.60.02, filed on Sep. 19, 2002, which claims priority from U.S. provisional patent application Ser. No. 60/326,886, attorney docket no. 25791.60, filed on Oct. 3, 2001, (38) PCT Application US02/20256, attorney docket no. 25791.61.02, filed on Jun. 26, 2002, which claims priority from U.S. provisional patent application Ser. No. 60/303,740, attorney docket no. 25791.61, filed on Jul. 6, 2001, (39) U.S. patent application Ser. No. 09/962,469, filed on Sep. 25, 2001, attorney docket no. 25791.62, which is a divisional of U.S. patent application Ser. No. 09/523,468, attorney docket no. 25791.11.02, filed on Mar. 10, 2000, which claims priority from provisional application 60/124,042, filed on Mar. 11, 1999, (40) U.S. patent application Ser. No. 09/962,470, filed on Sep. 25, 2001, attorney docket no. 25791.63, which is a divisional of U.S. patent application Ser. No. 09/523,468, attorney docket no. 25791.11.02, filed on Mar. 10, 2000, which claims priority from provisional application 60/124,042, filed on Mar. 11, 1999, (41) U.S. patent application Ser. No. 09/962,471, filed on Sep. 25, 2001, attorney docket no. 25791.64, which is a divisional of U.S. patent application Ser. No. 09/523,468, attorney docket no. 25791.11.02, filed on Mar. 10, 2000, which claims priority from provisional application 60/124,042, filed on Mar. 11, 1999, (42) U.S. patent application Ser. No. 09/962,467, filed on Sep. 25, 2001, attorney docket no. 25791.65, which is a divisional of U.S. patent application Ser. No. 09/523,468, attorney docket no. 25791.11.02, filed on Mar. 10, 2000, which claims priority from provisional application 60/124,042, filed on Mar. 11, 1999, (43) U.S. patent application Ser. No. 09/962,468, filed on Sep. 25, 2001, attorney docket no. 25791.66, which is a divisional of U.S. patent application Ser. No. 09/523,468, attorney docket no. 25791.11.02, filed on Mar. 10, 2000, which claims priority from provisional application 60/124,042, filed on Mar. 11, 1999, (44) PCT application US 02/25727, filed on Aug. 14, 2002, attorney docket no. 25791.67.03, which claims priority from U.S. provisional patent application Ser. No. 60/317,985, attorney docket no. 25791.67, filed on Sep. 6, 2001, and U.S. provisional patent application Ser. No. 60/318,386, attorney docket no. 25791.67.02, filed on Sep. 10, 2001, (45) PCT application US 02/39425, filed on Dec. 10, 2002, attorney docket no. 25791.68.02, which claims priority from U.S. provisional patent application Ser. No. 60/343,674, attorney docket no. 25791.68, filed on Dec. 27, 2001, (46) U.S. utility patent application Ser. No. 09/969,922, attorney docket no. 25791.69, filed on Oct. 3, 2001, which is a continuation-in-part application of U.S. Pat. No. 6,328,113, which was filed as U.S. patent application Ser. No. 09/440,338, attorney docket number 25791.9.02, filed on Nov. 15, 1999, which claims priority from provisional application 60/108,558, filed on Nov. 16, 1998, (47) U.S. utility patent application Ser. No. 10/516,467, attorney docket no. 25791.70, filed on Dec. 10, 2001, which is a continuation application of U.S. utility patent application Ser. No. 09/969,922, attorney docket no. 25791.69, filed on Oct. 3, 2001, which is a continuation-in-part application of U.S. Pat. No. 6,328,113, which was filed as U.S. patent application Ser. No. 09/440,338, attorney docket number 25791.9.02, filed on Nov. 15, 1999, which claims priority from provisional application 60/108,558, filed on Nov. 16, 1998, (48) PCT application US 03/00609, filed on Jan. 9, 2003, attorney docket no. 25791.71.02, which claims priority from U.S. provisional patent application Ser. No. 60/357,372, attorney docket no. 25791.71, filed on Feb. 15, 2002, (49) U.S. patent application Ser. No. 10/074,703, attorney docket no. 25791.74, filed on Feb. 12, 2002, which is a divisional of U.S. Pat. No. 6,568,471, which was filed as patent application Ser. No. 09/512,895, attorney docket no. 25791.12.02, filed on Feb. 24, 2000, which claims priority from provisional application 60/121,841, filed on Feb. 26, 1999, (50) U.S. patent application Ser. No.10/074,244, attorney docket no. 25791.75, filed on Feb. 12, 2002, which is a divisional of U.S. Pat. No. 6,568,471, which was filed as patent application Ser. No. 09/512,895, attorney docket no. 25791.12.02, filed on Feb. 24, 2000, which claims priority from provisional application 60/121,841, filed on Feb. 26, 1999, (51) U.S. patent application Ser. No. 10/076,660, attorney docket no. 25791.76, filed on Feb. 15, 2002, which is a divisional of U.S. Pat. No. 6,568,471, which was filed as patent application Ser. No. 09/512,895, attorney docket no. 25791.12.02, filed on Feb. 24, 2000, which claims priority from provisional application 60/121,841, filed on Feb. 26, 1999, (52) U.S. patent application Ser. No. 10/076,661, attorney docket no. 25791.77, filed on Feb. 15, 2002, which is a divisional of U.S. Pat. No. 6,568,471, which was filed as patent application serial no. 09/512,895, attorney docket no. 25791.12.02, filed on Feb. 24, 2000, which claims priority from provisional application 60/121,841, filed on Feb. 26, 1999, (53) U.S. patent application Ser. No. 10/076,659, attorney docket no. 25791.78, filed on Feb. 15, 2002, which is a divisional of U.S. Pat. No. 6,568,471, which was filed as patent application Ser. No. 09/512,895, attorney docket no. 25791.12.02, filed on Feb. 24, 2000, which claims priority from provisional application 60/121,841, filed on Feb. 26, 1999, (54) U.S. patent application Ser. No. 10/078,928, attorney docket no. 25791.79, filed on Feb. 20, 2002, which is a divisional of U.S. Pat. No. 6,568,471, which was filed as patent application Ser. No. 09/512,895, attorney docket no. 25791.12.02, filed on Feb. 24, 2000, which claims priority from provisional application 60/121,841, filed on Feb. 26, 1999, (55) U.S. patent application Ser. No. 10/078,922, attorney docket no. 25791.80, filed on Feb. 20, 2002, which is a divisional of U.S. Pat. No. 6,568,471, which was filed as patent application Ser. No. 09/512,895, attorney docket no. 25791.12.02, filed on Feb. 24, 2000, which claims priority from provisional application 60/121,841, filed on Feb. 26, 1999, (56) U.S. patent application Ser. No. 10/078,921, attorney docket no. 25791.81, filed on Feb. 20, 2002, which is a divisional of U.S. Pat. No. 6,568,471, which was filed as patent application Ser. No. 09/512,895, attorney docket no. 25791.12.02, filed on Feb. 24, 2000, which claims priority from provisional application 60/121,841, filed on Feb. 26, 1999, (57) U.S. patent application Ser. No. 10/261,928, attorney docket no. 25791.82, filed on Oct. 1, 2002, which is a divisional of U.S. Pat. No. 6,557,640, which was filed as patent application Ser. No. 09/588,946, attorney docket no. 25791.17.02, filed on Jun. 7, 2000, which claims priority from provisional application 60/137,998, filed on Jun. 7, 1999, (58) U.S. patent application Ser. No. 10/079,276, attorney docket no. 25791.83, filed on Feb. 20, 2002, which is a divisional of U.S. Pat. No. 6,568,471, which was filed as patent application Ser. No. 09/512,895, attorney docket no. 25791.12.02, filed on Feb. 24, 2000, which claims priority from provisional application 60/121,841, filed on Feb. 26, 1999, (59) U.S. patent application Ser. No. 10/262,009, attorney docket no. 25791.84, filed on Oct. 1, 2002, which is a divisional of U.S. Pat. No. 6,557,640, which was filed as patent application Ser. No. 09/588,946, attorney docket no. 25791.17.02, filed on Jun. 7, 2000, which claims priority from provisional application 60/137,998, filed on Jun. 7, 1999, (60) U.S. patent application Ser. No. 10/092,481, attorney docket no. 25791.85, filed on Mar. 7, 2002, which is a divisional of U.S. Pat. No. 6,568,471, which was filed as patent application Ser. No. 09/512,895, attorney docket no. 25791.12.02, filed on Feb. 24, 2000, which claims priority from provisional application 60/121,841, filed on Feb. 26, 1999, (61) U.S. patent application Ser. No. 10/261,926, attorney docket no. 25791.86, filed on Oct. 1, 2002, which is a divisional of U.S. Pat. No. 6,557,640, which was filed as patent application Ser. No. 09/588,946, attorney docket no. 25791.17.02, filed on Jun. 7, 2000, which claims priority from provisional application 60/137,998, filed on Jun. 7, 1999, (62) PCT application US 02/36157, filed on Nov. 12, 2002, attorney docket no. 25791.87.02, which claims priority from U.S. provisional patent application Ser. No. 60/338,996, attorney docket no. 25791.87, filed on Nov. 12, 2001, (63) PCT application US 02/36267, filed on Nov. 12, 2002, attorney docket no. 25791.88.02, which claims priority from U.S. provisional patent application Ser. No. 60/339,013, attorney docket no. 25791.88, filed on Nov. 12, 2001, (64) PCT application US 03/11765, filed on Apr. 16, 2003, attorney docket no. 25791.89.02, which claims priority from U.S. provisional patent application Ser. No. 60/383,917, attorney docket no. 25791.89, filed on May 29, 2002, (65) PCT application US 03/15020, filed on May 12, 2003, attorney docket no. 25791.90.02, which claims priority from U.S. provisional patent application Ser. No. 60/391,703, attorney docket no. 25791.90, filed on Jun. 26, 2002, (66) PCT application US 02/39418, filed on Dec. 10, 2002, attorney docket no. 25791.92.02, which claims priority from U.S. provisional patent application Ser. No. 60/346,309, attorney docket no. 25791.92, filed on Jan. 7, 2002, (67) PCT application US 03/06544, filed on Mar. 4, 2003, attorney docket no. 25791.93.02, which claims priority from U.S. provisional patent application Ser. No. 60/372,048, attorney docket no. 25791.93, filed on Apr. 12, 2002, (68) U.S. patent application Ser. No. 10/331,718, attorney docket no. 25791.94, filed on Dec. 30, 2002, which is a divisional U.S. patent application Ser. No. 09/679,906, filed on Oct. 5, 2000, attorney docket no. 25791.37.02, which claims priority from provisional patent application Ser. No. 60/159,033, attorney docket no. 25791.37, filed on Oct. 12, 1999, (69) PCT application US 03/04837, filed on Feb. 29, 2003, attorney docket no. 25791.95.02, which claims priority from U.S. provisional patent application Ser. No. 60/363,829, attorney docket no. 25791.95, filed on Mar. 13, 2002, (70) U.S. patent application Ser. No. 10/261,927, attorney docket no. 25791.97, filed on Oct. 1, 2002, which is a divisional of U.S. Pat. No. 6,557,640, which was filed as patent application Ser. No. 09/588,946, attorney docket no. 25791.17.02, filed on Jun. 7, 2000, which claims priority from provisional application 60/137,998, filed on Jun. 7, 1999, (71) U.S. patent application Ser. No. 10/262,008, attorney docket no. 25791.98, filed on Oct. 1, 2002, which is a divisional of U.S. Pat. No. 6,557,640, which was filed as patent application Ser. No. 09/588,946, attorney docket no. 25791.17.02, filed on Jun. 7, 2000, which claims priority from provisional application 60/137,998, filed on Jun. 7, 1999, (72) U.S. patent application Ser. No. 10/261,925, attorney docket no. 25791.99, filed on Oct. 1, 2002, which is a divisional of U.S. Pat. No. 6,557,640, which was filed as patent application Ser. No. 09/588,946, attorney docket no. 25791.17.02, filed on Jun. 7, 2000, which claims priority from provisional application 60/137,998, filed on Jun. 7, 1999, (73) U.S. patent application Ser. No. 10/199,524, attorney docket no. 25791.100, filed on Jul. 19, 2002, which is a continuation of U.S. Pat. No. 6,497,289, which was filed as U.S. patent application Ser. No. 09/454,139, attorney docket no. 25791.03.02, filed on Dec. 3, 1999, which claims priority from provisional application 60/111,293, filed on Dec. 7, 1998, (74) PCT application US 03/10144, filed on Mar. 28, 2003, attorney docket no. 25791.101.02, which claims priority from U.S. provisional patent application Ser. No. 60/372,632, attorney docket no. 25791.101, filed on Apr. 15, 2002, (75) U.S. provisional patent application Ser. No. 60/412,542, attorney docket no. 25791.102, filed on Sep. 20, 2002, (76) PCT application US 03/14153, filed on May. 6, 2003, attorney docket no. 25791.104.02, which claims priority from U.S. provisional patent application Ser. No. 60/380,147, attorney docket no. 25791.104, filed on May. 6, 2002, (77) PCT application US 03/19993, filed on Jun. 24, 2003, attorney docket no. 25791.106.02, which claims priority from U.S. provisional patent application Ser. No. 60/397,284, attorney docket no. 25791.106, filed on Jul. 19, 2002, (78) PCT application US 03/13787, filed on May. 5, 2003, attorney docket no. 25791.107.02, which claims priority from U.S. provisional patent application Ser. No. 60/387,486, attorney docket no. 25791.107, filed on Jun. 10, 2002, (79) PCT application US 03/18530, filed on Jun. 11, 2003, attorney docket no. 25791.108.02, which claims priority from U.S. provisional patent application Ser. No. 60/387,961, attorney docket no. 25791.108, filed on Jun. 12, 2002, (80) PCT application US 03/20694, filed on Jul. 1, 2003, attorney docket no. 25791.110.02, which claims priority from U.S. provisional patent application Ser. No. 60/398,061, attorney docket no. 25791.110, filed on Jul. 24, 2002, (81) PCT application US 03/20870, filed on Jul. 2, 2003, attorney docket no. 25791.111.02, which claims priority from U.S. provisional patent application Ser. No. 60/399,240, attorney docket no. 25791.111, filed on Jul. 29, 2002, (82) U.S. provisional patent application Ser. No. 60/412,487, attorney docket no. 25791.112, filed on Sep. 20, 2002, (83) U.S. provisional patent application Ser. No. 60/412,488, attorney docket no. 25791.114, filed on Sep. 20, 2002, (84) U.S. patent application Ser. No. 10/280,356, attorney docket no. 25791.115, filed on Oct. 25, 2002, which is a continuation of U.S. Pat. No. 6,470,966, which was filed as patent application Ser. No. 09/850,093, filed on May. 7, 2001, attorney docket no. 25791.55, as a divisional application of U.S. Pat. No. 6,497,289, which was filed as U.S. patent application Ser. No. 09/454,139, attorney docket no. 25791.03.02, filed on Dec. 3, 1999, which claims priority from provisional application 60/111,293, filed on Dec. 7, 1998, (85) U.S. provisional patent application Ser. No. 60/412,177, attorney docket no. 25791.117, filed on Sep. 20, 2002, (86) U.S. provisional patent application Ser. No. 60/412,653, attorney docket no. 25791.118, filed on Sep. 20. 2002, (87) U.S. provisional patent application Ser. No. 60/405,610, attorney docket no. 25791.119, filed on Aug. 23, 2002, (88) U.S. provisional patent application Ser. No. 60/405,394, attorney docket no. 25791.120, filed on Aug. 23, 2002, (89) U.S. provisional patent application Ser. No. 60/412,544, attorney docket no. 25791.121, filed on Sep. 20, 2002, (90) PCT application US 03/24779, filed on Aug. 8, 2003, attorney docket no. 25791.125.02, which claims priority from U.S. provisional patent application Ser. No. 60/407,442, attorney docket no. 25791.125, filed on Aug. 30, 2002, (91) U.S. provisional patent application Ser. No. 60/423,363, attorney docket no. 25791.126, filed on Dec. 10, 2002, (92) U.S. provisional patent application Ser. No. 60/412,196, attorney docket no. 25791.127, filed on Sep. 20, 2002, (93) U.S. provisional patent application Ser. No. 60/412,187, attorney docket no. 25791.128, filed on Sep. 20, 2002, (94) U.S. provisional patent application Ser. No. 60/412,371, attorney docket no. 25791.129, filed on Sep. 20, 2002, (95) U.S. patent application Ser. No. 10/382,325, attorney docket no. 25791.145, filed on Mar. 5, 2003, which is a continuation of U.S. Pat. No. 6,557,640, which was filed as patent application Ser. No. 09/588,946, attorney docket no. 25791.17.02, filed on Jun. 7, 2000, which claims priority from provisional application 60/137,998, filed on Jun. 7, 1999, (96) U.S. patent application Ser. No. 10/624,842, attorney docket no. 25791.151, filed on Jul. 22, 2003, which is a divisional of U.S. patent application Ser. No. 09/502,350, attorney docket no. 25791.8.02, filed on Feb. 10, 2000, which claims priority from provisional application 60/119,611, filed on Feb. 11, 1999, (97) U.S. provisional patent application Ser. No. 60/431,184, attorney docket no. 25791.157, filed on Dec. 5, 2002, (98) U.S. provisional patent application Ser. No. 60/448,526, attorney docket no. 25791.185, filed on Feb. 18, 2003, (99) U.S. provisional patent application Ser. No. 60/461,539, attorney docket no. 25791.186, filed on Apr. 9, 2003, (100) U.S. provisional patent application Ser. No. 60/462,750, attorney docket no. 25791.193, filed on Apr. 14, 2003, (101) U.S. provisional patent application Ser. No. 60/436,106, attorney docket no. 25791.200, filed on Dec. 23, 2002, (102) U.S. provisional patent application Ser. No. 60/442,942, attorney docket no. 25791.213, filed on Jan. 27, 2003, (103) U.S. provisional patent application Ser. No. 60/442,938, attorney docket no. 25791.225, filed on Jan. 27, 2003, (104) U.S. provisional patent application Ser. No. 60/418,687, attorney docket no. 25791.228, filed on Apr. 18, 2003, (105) U.S. provisional patent application Ser. No. 60/454,896, attorney docket no. 25791.236, filed on Mar. 14, 2003, (106) U.S. provisional patent application Ser. No. 60/450,504, attorney docket no. 25791.238, filed on Feb. 26, 2003, (107) U.S. provisional patent application Ser. No. 60/451,152, attorney docket no. 25791.239, filed on Mar. 9, 2003, (108) U.S. provisional patent application Ser. No. 60/455,124, attorney docket no. 25791.241, filed on Mar. 17, 2003, (109) U.S. provisional patent application Ser. No. 60/453,678, attorney docket no. 25791.253, filed on Mar. 11, 2003, (110) U.S. patent application Ser. No. 10/421,682, attorney docket no. 25791.256, filed on Apr. 23, 2003, which is a continuation of U.S. patent application Ser. No. 09/523,468, attorney docket no. 25791.11.02, filed on Mar. 10, 2000, which claims priority from provisional application 60/124,042, filed on Mar. 11, 1999, (111) U.S. provisional patent application Ser. No. 60/457,965, attorney docket no. 25791.260, filed on Mar. 27, 2003, (112) U.S. provisional patent application Ser. No. 60/455,718, attorney docket no. 25791.262, filed on Mar. 18, 2003, (113) U.S. Pat. No. 6,550,821, which was filed as patent application Ser. No. 09/811,734, filed on Mar. 19, 2001, (114) U.S. patent application Ser. No. 10/436,467, attorney docket no. 25791.268, filed on May 12, 2003, which is a continuation of U.S. Pat. No. 6,604,763, which was filed as application Ser. No. 09/559,122, attorney docket no. 25791.23.02, filed on Apr. 26, 2000, which claims priority from provisional application 60/131,106, filed on Apr. 26, 1999, (115) U.S. provisional patent application Ser. No. 60/459,776, attorney docket no. 25791.270, filed on Apr. 2, 2003, (116) U.S. provisional patent application Ser. No. 60/461,094, attorney docket no. 25791.272, filed on Apr. 8, 2003,(117) U.S. provisional patent application Ser. No. 60/461,038, attorney docket no. 25791.273, filed on Apr. 7, 2003, (118) U.S. provisional patent application Ser. No. 60/463,586, attorney docket no. 25791.277, filed on Apr. 17, 2003, (119) U.S. provisional patent application Ser. No. 60/472,240, attorney docket no. 25791.286, filed on May 20, 2003, (120) U.S. patent application Ser. No. 10/619,285, attorney docket no. 25791.292, filed on Jul. 14, 2003, which is a continuation-in-part of U.S. utility patent application Ser. No. 09/969,922, attorney docket no. 25791.69, filed on Oct. 3, 2001, which is a continuation-in-part application of U.S. Pat. No. 6,328,113, which was filed as U.S. patent application Ser. No. 09/440,338, attorney docket number 25791.9.02, filed on Nov. 15, 1999, which claims priority from provisional application 60/108,558, filed on Nov. 16, 1998,(121) U.S. utility patent application Ser. No. 10/418,688, attorney docket no. 25791.257, which was filed on Apr. 18, 2003, as a division of U.S. utility patent application Ser. No. 09/523,468, attorney docket no. 25791.11.02, filed on Mar. 10, 2000, which claims priority from provisional application 60/124,042, filed on Mar. 11, 1999,(122) PCT patent application serial no. PCT/US04/06246, attorney docket no. 25791.238.02, filed on Feb. 26, 2004,(123) PCT patent application serial number PCT/US04/08170, attorney docket number 25791.40.02, filed on Mar. 15, 2004, (124) PCT patent application serial number PCT/US04/08171, attorney docket number 25791.236.02, filed on Mar. 15, 2004, (125) PCT patent application serial number PCT/US04/08073, attorney docket number 25791.262.02, filed on Mar. 18, 2004, (126) PCT patent application serial number PCT/US04/07711, attorney docket number 25791.253.02, filed on Mar. 11, 2004, (127) PCT patent application serial number PCT/US04/009434, attorney docket number 25791.260.02, filed on Mar. 26, 2004, (128) PCT patent application serial number PCT/US04/010317, attorney docket number 25791.270.02, filed on Apr. 2, 2004, (129) PCT patent application serial number PCT/US04/010712, attorney docket number 25791.272.02, filed on Apr. 7, 2004, (130) PCT patent application serial number PCT/US04/010762, attorney docket number 25791.273.02, filed on Apr. 6, 2004, (131) PCT patent application serial number PCT/US04/011973, attorney docket number 25791.277.02, filed on Apr. 15, 2004, (132) U.S. provisional patent application Ser. No. 60/495056, attorney docket number 25791.301, filed on Aug. 14, 2003,(133) U.S. provisional patent application Ser. No. 60/600,679, attorney docket number 25791.194, filed on Aug. 11, 2004, (134) U.S. provisional patent application Ser. No. 60/500,435 attorney docket number 25791.304, filed on Sep. 5, 2003,(134) PCT patent application serial number PCT/US2005/027318, attorney docket number 25791.329.02, filed on Jul. 29, 2005; (135) PCT patent application serial number PCT/US2005/028936, attorney docket number 25791.338.02, filed on Aug. 12, 2005; (136) PCT patent application serial number PCT/US2005/028669, attorney docket number 25791.194.02, filed on Aug. 11, 2005; (137) PCT patent application serial number PCT/US2005/028453, attorney docket number 25791.371, filed on Aug. 11, 2005; (138) PCT patent application serial number PCT/US2005/028641, attorney docket number 25791.372, filed on Aug. 11, 2005; (139) PCT patent application serial number PCT/US2005/028819, attorney docket number 25791.373, filed on Aug. 11, 2005; (140) PCT patent application serial number PCT/US2005/028446, attorney docket number 25791.374, filed on Aug. 11, 2005; (141) PCT patent application serial number PCT/US2005/028642, attorney docket number 25791.375, filed on Aug. 11, 2005; (142) PCT patent application serial number PCT/US2005/028451, attorney docket number 25791.376, filed on Aug. 11, 2005, and (143). PCT patent application serial number PCT/US2005/028473, attorney docket number 25791.377, filed on Aug. 11, 2005, the disclosures of which are incorporated herein by reference.

### BACKGROUND

The disclosures herein relate generally to expandable tubulars and more particularly to an expandable tubular lubrication.

Tubular members are typically expanded by forcing expansion devices through them along their lengths, which requires a large amount of force. Efforts to reduce the amount of force necessary to expand the tubular member have involved supplying lubrication between the expansion device and the inner surface of the tubular member. Present techniques includes lubricating the inner surface of the tubular member along with supplying oil between the expansion device and the inner surface by way of a oil delivery mechanism coupled to the expansion device. These oil delivery systems increase the complexity and cost of the process.

Accordingly, it would be desirable to provide an expandable tubular lubrication absent the disadvantages found in the prior methods discussed above.

### SUMMARY

According to one aspect of the present disclosure, a lubricant is provided comprising a lubricating substrate and a plurality of capsules in the lubricating substrate, the plurality of capsules containing a lubricating material.

According to one aspect of the present disclosure, an expandable tubular member is provided comprising a tubular member comprising an inner surface, a lubricating substrate coupled to the inner surface, and a plurality of capsules in the lubricating substrate, the plurality of capsules containing a lubricating material.

According to one aspect of the present disclosure, an expandable tubular member is provided comprising a tubular member comprising an inner surface and a means for selectively releasing a lubricating material adjacent the inner surface, the means for selectively releasing a lubricating material coupled to the inner surface.

According to one aspect of the present disclosure, a method for lubricating an expandable tubular member is provided comprising providing an expandable tubular member comprising an inner surface, coupling a lubricating substrate to the inner surface, the lubricating substrate comprising a plurality of capsules containing a lubricating material, and selectively releasing the lubricating material adjacent the inner surface.

According to one aspect of the present disclosure, a lubricant is provided comprising a dry film lubricant and a plurality of microcapsules dispersed throughout the dry film lubricant and each comprising a semi-hard shelled material containing an oil, the semi-hard shelled material operable to open under pressure and release the oil.

According to one aspect of the present disclosure, an expandable tubular member is provided comprising a tubular member comprising an inner surface, a dry film lubricant coupled to the inner surface, and a plurality of microcapsules dispersed through the dry film lubricant and each comprising a semi-hard shelled material containing an oil, the semi-hard shelled material operable to open under pressure and release the oil.

According to one aspect of the present disclosure, an expandable tubular member is provided comprising a tubular member comprising an inner surface, a means for reducing friction on the inner surface coupled to the inner surface, and a means for selectively releasing a lubricating material in the means for reducing friction on the inner surface.

According to one aspect of the present disclosure, a method for expanding an expandable tubular member is provided comprising providing an expandable tubular member comprising an inner surface, applying a film of lubricant that dries to the inner surface, the film of lubricant comprising a plurality of microcapsules, the plurality of microcapsules each comprising a semi-hard shelled material containing an oil, positioning the expandable tubular member in a well bore, expanding the expandable tubular member by moving an expansion device through the expandable tubular member, opening the semi-hard shelled material to release the oil between the expansion device and the inner surface as the expansion device moves through the expandable tubular member.

### BRIEF DESCRIPTION OF THE DRAWINGS

FIG. 1 is a cross sectional view illustrating an exemplary embodiment of a capsule.

FIG. 2 is a cross sectional view illustrating an exemplary embodiment of a lubricating substrate including a plurality of the capsules of FIG. 1.

FIG. 3a is a perspective view illustrating an exemplary embodiment of an expandable tubular member.

FIG. 3b is a cross sectional view illustrating an exemplary embodiment of the expandable tubular member of FIG. 3a.

FIG. 4a is a flow chart illustrating an exemplary embodiment of a method for lubricating an expandable tubular member.

FIG. 4b is a perspective view illustrating an exemplary embodiment of the expandable tubular member of FIG. 3a with the lubricating substrate of FIG. 2 on its inner surface.

FIG. 4c is a cross sectional view illustrating an exemplary embodiment of the expandable tubular member of FIG. 4b with the lubricating substrate on its inner surface.

FIG. 4d is a close up cross sectional view illustrating an exemplary embodiment of the expandable tubular member of FIG. 4c including the lubricating substrate on its inner surface.

FIG. 4e is a cross sectional view illustrating an exemplary embodiment of an expansion device positioned in and moved through the expandable tubular member of FIG. 4c.

FIG. 4f is a close up cross sectional view illustrating an exemplary embodiment of the expansion device and expandable tubular member of FIG. 4e.

### DETAILED DESCRIPTION

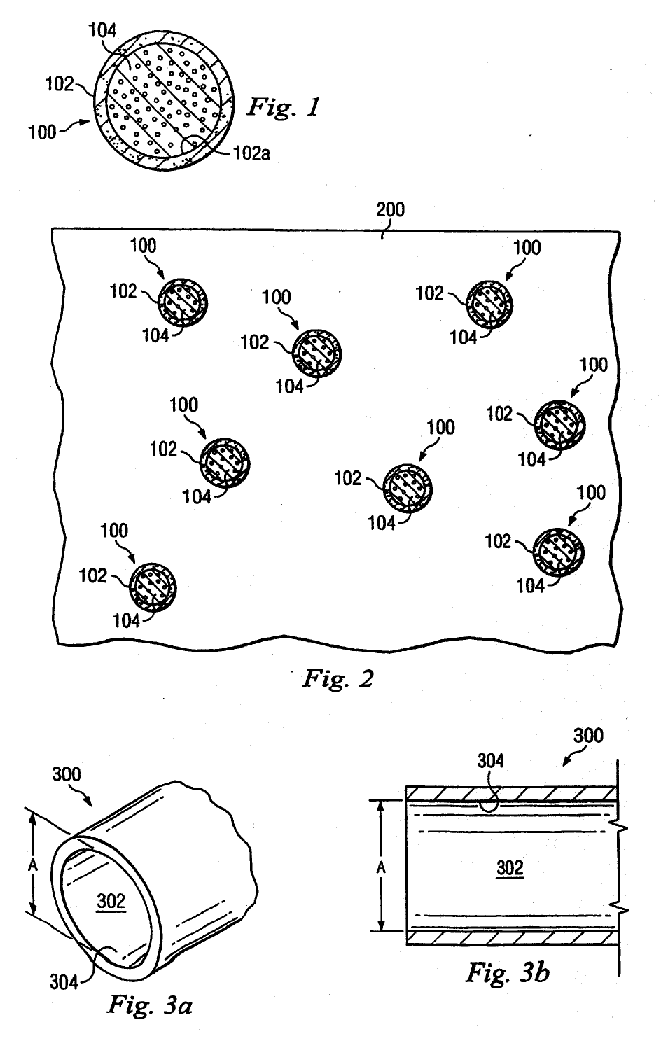

Referring now to FIG. 1, in an exemplary embodiment, a spherical lubricating material delivery capsule 100 is illustrated and includes a shell 102 which defines a substantially spherical cavity 102a within the shell 102. A lubricating material 104 is contained within the shell 102 in cavity 102a. In an exemplary embodiment, the shell 102 includes a semi-hard shell material such as, for example, a wax, a polymer, a resin, or a variety of other equivalent materials known in the art. In an exemplary embodiment, the capsule may be a microsphere or a nanosphere. In an exemplary embodiment, the capsule may be a commercially available conventional microencapsulated product such as, for example, microencapsulated products available from Southwest Research Institute, 6220 Culebra Rd., San Antonio, Tex., 78238-5166, http://www.swri.org/.

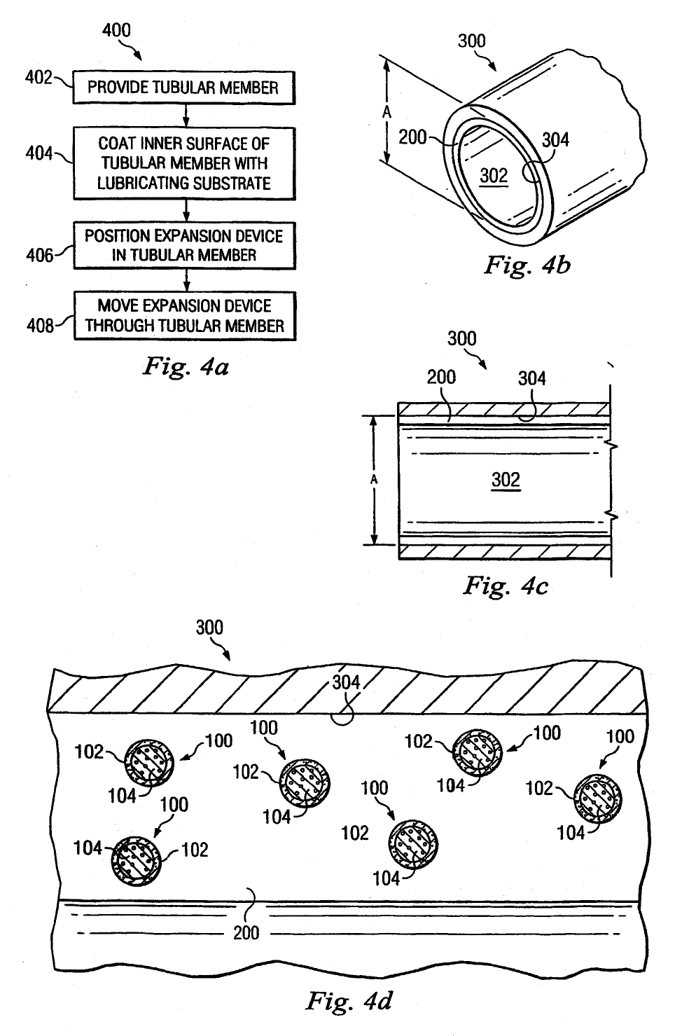

Referring now to FIG. 2, a lubricating substrate 200 is illustrated. A plurality of the capsules 100 are dispersed throughout the lubricating substrate 200. In an exemplary embodiment, the lubricating substrate 200 is operable to adhere to a surface. In an exemplary embodiment, the capsules 100 and lubricating substrate 200 are designed such that the capsules 100 are substantially suspended in the lubricating substrate 200. In an exemplary embodiment, the lubricating substrate includes a lubricating substrate with a chemical composition of 20%-26% Methyl Ethyl Ketone, 20%-25% Titanium dioxide, 4-15% Polytetraflouro ethylene, and 40-50% Alkyd Resin CAS. In several exemplary embodiments, the lubricating substrate 200 may include, for example, a dry film lubricant, a wet film lubricant, and/or a variety of equivalent lubricants known in the art.

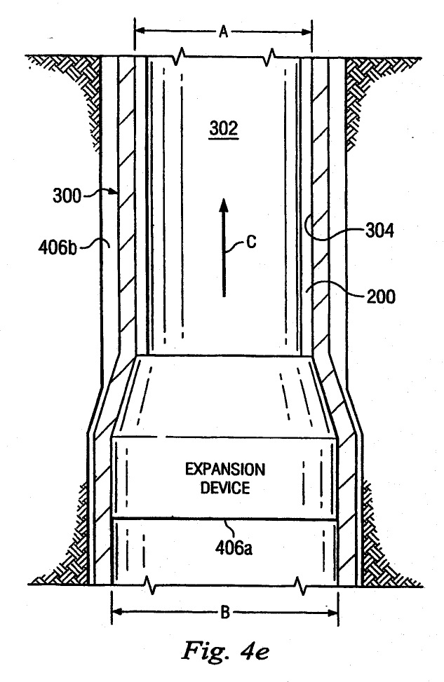

Referring now to FIGS. 3a and 3b, an expandable tubular member 300 defines a passageway 302 running the length of the tubular member 300 and an inner surface 304 adjacent the passagway 302. In an exemplary embodiment, the tubular member 300 has a constant inner diameter A along its length.

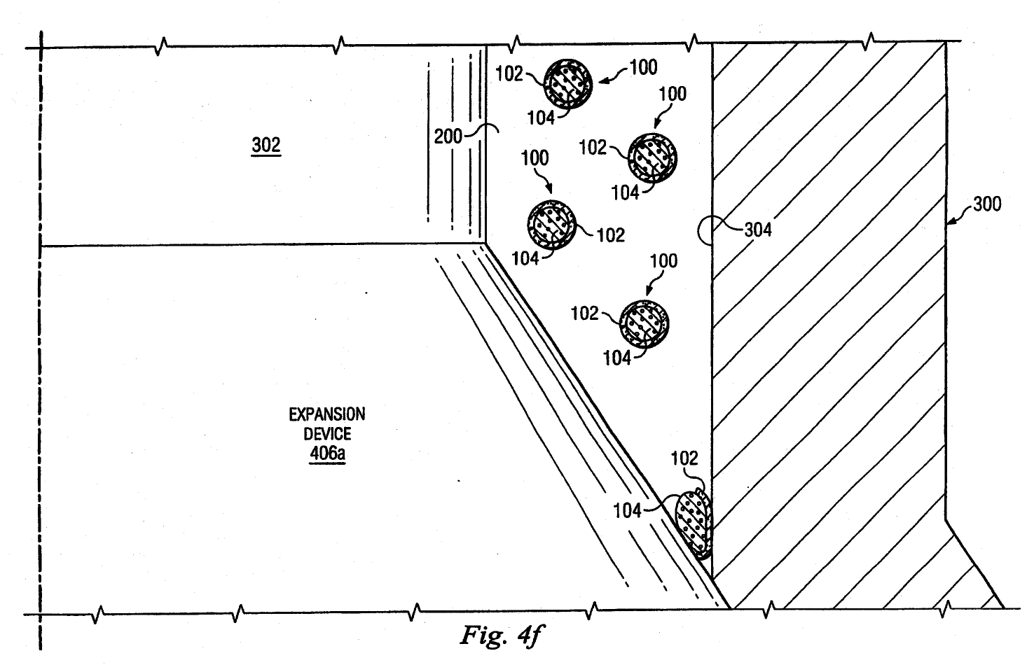

Referring now to FIG. 4a, a method 400 for lubricating an expandable tubular member begins at step 402 in which an expandable tubular member such as, for example, the expandable tubular member 300 described above with reference to FIGS. 3a and 3b, is provided. In an embodiment, the expandable tubular member 300 is a conventional expandable tubular member known in the art.

Referring now to FIGS. 4a, 4b, 4c, and 4d, the method 400 proceeds to step 404 where the inner surface 304 of expandable tubular member 300 is coated with the lubricating substrate 200. The lubricating substrate 200 is coated on the inner surface 304 of the expandable tubular member 300 and in and along the length the passageway 302 using conventional coating methods known in the art and/or coating methods described in (1) U.S. Pat. No. 6,497,289, which was filed as U.S. patent application Ser. No. 09/454,139, attorney docket no. 25791.03.02, filed on Dec. 3, 1999, which claims priority from provisional application 60/111,293, filed on Dec. 7, 1998, (2) U.S. patent application Ser. No. 09/510,913, attorney docket no. 25791.7.02, filed on Feb. 23, 2000, which claims priority from provisional application 60/121,702, filed on Feb. 25, 1999, (3) U.S. patent application Ser. No. 09/502,350, attorney docket no. 25791.8.02, filed on Feb. 10, 2000, which claims priority from provisional application 60/119,611, filed on Feb. 11, 1999, (4) U.S. Pat. No. 6,328,113, which was filed as U.S. patent application Ser. No. 09/440,338, attorney docket number 25791.9.02, filed on Nov. 15, 1999, which claims priority from provisional application 60/108,558, filed on Nov. 16, 1998, (5) U.S. patent application Ser. No. 10/169,434, attorney docket no. 25791.10.04, filed on Jul. 1, 2002, which claims priority from provisional application 60/183,546, filed on Feb. 18, 2000, (6) U.S. patent application Ser. No. 09/523,468, attorney docket no. 25791.11.02, filed on Mar. 10, 2000, which claims priority from provisional application 60/124,042, filed on Mar. 11, 1999, (7) U.S. Pat. No. 6,568,471, which was filed as patent application Ser. No. 09/512,895, attorney docket no. 25791.12.02, filed on Feb. 24, 2000, which claims priority from provisional application 60/121,841, filed on Feb. 26, 1999, (8) U.S. Pat. No. 6,575,240, which was filed as patent application Ser. No. 09/511,941, attorney docket no. 25791.16.02, filed on Feb. 24, 2000, which claims priority from provisional application 60/121,907, filed on Feb. 26, 1999, (9) U.S. Pat. No. 6,557,640, which was filed as patent application Ser. No. 09/588,946, attorney docket no. 25791.17.02, filed on Jun. 7, 2000, which claims priority from provisional application 60/137,998, filed on Jun. 7, 1999, (10) U.S. patent application Ser. No. 09/981,916, attorney docket no. 25791.18, filed on Oct. 18, 2001 as a continuation-in-part application of U.S. Pat. No. 6,328,113, which was filed as U.S. patent application Ser. No. 09/440,338, attorney docket number 25791.9.02, filed on Nov. 15, 1999, which claims priority from provisional application 60/108,558, filed on Nov. 16, 1998, (11) U.S. Pat. No. 6,604,763, which was filed as application Ser. No. 09/559,122, attorney docket no. 25791.23.02, filed on Apr. 26, 2000, which claims priority from provisional application 60/131,106, filed on Apr. 26, 1999, (12) U.S. patent application Ser. No. 10/030,593, attorney docket no. 25791.25.08, filed on Jan. 8, 2002, which claims priority from provisional application 60/146,203, filed on Jul. 29, 1999, (13) U.S. provisional patent application Ser. No. 60/143,039, attorney docket no. 25791.26, filed on Jul. 9, 1999, (14) U.S. patent application Ser. No. 10/111,982, attorney docket no. 25791.27.08, filed on Apr. 30, 2002, which claims priority from provisional patent application Ser. No. 60/162,671, attorney docket no. 25791.27, filed on Nov. 1, 1999, (15) U.S. provisional patent application Ser. No. 60/154,047, attorney docket no. 25791.29, filed on Sep. 16, 1999, (16) U.S. provisional patent application Ser. No. 60/438,828, attorney docket no. 25791.31, filed on Jan. 9, 2003, (17) U.S. Pat. No. 6,564,875, which was filed as application Ser. No. 09/679,907, attorney docket no. 25791.34.02, on Oct. 5, 2000, which claims priority from provisional patent application Ser. No. 60/159,082, attorney docket no. 25791.34, filed on Oct. 12, 1999, (18) U.S. patent application Ser. No. 10/089,419, filed on Mar. 27, 2002, attorney docket no. 25791.36.03, which claims priority from provisional patent application Ser. No. 60/159,039, attorney docket no. 25791.36, filed on Oct. 12, 1999, (19) U.S. patent application Ser. No. 09/679,906, filed on Oct. 5, 2000, attorney docket no. 25791.37.02, which claims priority from provisional patent application Ser. No. 60/159,033, attorney docket no. 25791.37, filed on Oct. 12, 1999, (20) U.S. patent application Ser. No. 10/303,992, filed on Nov. 22, 2002, attorney docket no. 25791.38.07, which claims priority from provisional patent application Ser. No. 60/212,359, attorney docket no. 25791.38, filed on Jun. 19, 2000, (21) U.S. provisional patent application Ser. No. 60/165,228, attorney docket no. 25791.39, filed on Nov. 12, 1999, (22) U.S. provisional patent application Ser. No. 60/455,051, attorney docket no. 25791.40, filed on Mar. 14, 2003, (23) PCT application US02/2477, filed on Jun. 26, 2002, attorney docket no. 25791.44.02, which claims priority from U.S. provisional patent application Ser. No. 60/303,71 1, attorney docket no. 25791.44, filed on Jul. 6, 2001, (24) U.S. patent application Ser. No. 10/311,412, filed on Dec. 12, 2002, attorney docket no. 25791.45.07, which claims priority from provisional patent application Ser. No. 60/221,443, attorney docket no. 25791.45, filed on Jul. 28, 2000, (25) U.S. patent application Ser. No. 10/______, filed on Dec. 18, 2002, attorney docket no. 25791.46.07, which claims priority from provisional patent application Ser. No. 60/221,645, attorney docket no. 25791.46, filed on Jul. 28, 2000, (26) U.S. patent application Ser. No. 10/322,947, filed on Jan. 22, 2003, attorney docket no. 25791.47.03, which claims priority from provisional patent application Ser. No. 60/233,638, attorney docket no. 25791.47, filed on Sep. 18, 2000, (27) U.S. patent application Ser. No. 10/406,648, filed on Mar. 31, 2003, attorney docket no. 25791.48.06, which claims priority from provisional patent application Ser. No. 60/237,334, attorney docket no. 25791.48, filed on Oct. 2, 2000, (28) PCT application US02/04353, filed on Feb. 14, 2002, attorney docket no. 25791.50.02, which claims priority from U.S. provisional patent application Ser. No. 60/270,007, attorney docket no. 25791.50, filed on Feb. 20, 2001, (29) U.S. patent application Ser. No. 10/465,835, filed on Jun. 13, 2003, attorney docket no. 25791.51.06, which claims priority from provisional patent application Ser. No. 60/262,434, attorney docket no. 25791.51, filed on Jan. 17, 2001, (30) U.S. patent application Ser. No. 10/465,831, filed on Jun. 13, 2003, attorney docket no. 25791.52.06, which claims priority from U.S. provisional patent application Ser. No. 60/259,486, attorney docket no. 25791.52, filed on Jan. 3, 2001, (31) U.S. provisional patent application Ser. No. 60/452,303, filed on Mar. 5, 2003, attorney docket no. 25791.53, (32) U.S. Pat. No. 6,470,966, which was filed as patent application Ser. No. 09/850,093, filed on May 7, 2001, attorney docket no. 25791.55, as a divisional application of U.S. Pat. No. 6,497,289, which was filed as U.S. patent application Ser. No. 09/454,139, attorney docket no. 25791.03.02, filed on Dec. 3, 1999, which claims priority from provisional application 60/111,293, filed on Dec. 7, 1998, (33) U.S. Pat. No. 6,561,227, which was filed as patent application Ser. No. 09/852,026, filed on May 9, 2001, attorney docket no. 25791.56, as a divisional application of U.S. Pat. No. 6,497,289, which was filed as U.S. patent application Ser. No. 09/454,139, attorney docket no. 25791.03.02, filed on Dec. 3, 1999, which claims priority from provisional application 60/111,293, filed on Dec. 7, 1998, (34) U.S. patent application Ser. No. 09/852,027, filed on May 9, 2001, attorney docket no. 25791.57, as a divisional application of U.S. Pat. No. 6,497,289, which was filed as U.S. patent application Ser. No. 09/454,139, attorney docket no. 25791.03.02, filed on Dec. 3, 1999, which claims priority from provisional application 60/111,293, filed on Dec. 7, 1998, (35) PCT Application US02/25608, attorney docket no. 25791.58.02, filed on Aug. 13, 2002, which claims priority from provisional application 60/318,021, filed on Sep. 7, 2001, attorney docket no. 25791.58, (36) PCT Application US02/24399, attorney docket no. 25791.59.02, filed on Aug. 1, 2002, which claims priority from U.S. provisional patent application Ser. No. 60/313,453, attorney docket no. 25791.59, filed on Aug. 20, 2001, (37) PCT Application US02/29856, attorney docket no. 25791.60.02, filed on Sep. 19, 2002, which claims priority from U.S. provisional patent application Ser. No. 60/326,886, attorney docket no. 25791.60, filed on Oct. 3, 2001, (38) PCT Application US02/20256, attorney docket no. 25791.61.02, filed on Jun. 26, 2002, which claims priority from U.S. provisional patent application Ser. No. 60/303,740, attorney docket no. 25791.61, filed on Jul. 6, 2001, (39) U.S. patent application Ser. No. 09/962,469, filed on Sep. 25, 2001, attorney docket no. 25791.62, which is a divisional of U.S. patent application Ser. No. 09/523,468, attorney docket no. 25791.11.02, filed on Mar. 10, 2000, which claims priority from provisional application 60/124,042, filed on Mar. 11, 1999, (40) U.S. patent application Ser. No. 09/962,470, filed on Sep. 25, 2001, attorney docket no. 25791.63, which is a divisional of U.S. patent application Ser. No. 09/523,468, attorney docket no. 25791.11.02, filed on Mar. 10, 2000, which claims priority from provisional application 60/124,042, filed on Mar. 11, 1999, (41) U.S. patent application Ser. No. 09/962,471, filed on Sep. 25, 2001, attorney docket no. 25791.64, which is a divisional of U.S. patent application Ser. No. 09/523,468, attorney docket no. 25791.11.02, filed on Mar. 10, 2000, which claims priority from provisional application 60/124,042, filed on Mar. 11, 1999, (42) U.S. patent application Ser. No. 09/962,467, filed on Sep. 25, 2001, attorney docket no. 25791.65, which is a divisional of U.S. patent application Ser. No. 09/523,468, attorney docket no. 25791.11.02, filed on Mar. 10, 2000, which claims priority from provisional application 60/124,042, filed on Mar. 11, 1999, (43) U.S. patent application Ser. No. 09/962,468, filed on Sep. 25, 2001, attorney docket no. 25791.66, which is a divisional of U.S. patent application Ser. No. 09/523,468, attorney docket no. 25791.11.02, filed on Mar. 10, 2000, which claims priority from provisional application 60/124,042, filed on Mar. 11, 1999, (44) PCT application US 02/25727, filed on Aug. 14, 2002, attorney docket no. 25791.67.03, which claims priority from U.S. provisional patent application Ser. No. 60/317,985, attorney docket no. 25791.67, filed on Sep. 6, 2001, and U.S. provisional patent application Ser. No. 60/318,386, attorney docket no. 25791.67.02, filed on Sep. 10, 2001, (45) PCT application US 02/39425, filed on Dec. 10, 2002, attorney docket no. 25791.68.02, which claims priority from U.S. provisional patent application Ser. No. 60/343,674, attorney docket no. 25791.68, filed on Dec. 27, 2001, (46) U.S. utility patent application Ser. No. 09/969,922, attorney docket no. 25791.69, filed on Oct. 3, 2001, which is a continuation-in-part application of U.S. Pat. No. 6,328,113, which was filed as U.S. patent application Ser. No. 09/440,338, attorney docket number 25791.9.02, filed on Nov. 15, 1999, which claims priority from provisional application 60/108,558, filed on Nov. 16, 1998, (47) U.S. utility patent application Ser. No. 10/516,467, attorney docket no. 25791.70, filed on Dec. 10, 2001, which is a continuation application of U.S. utility patent application Ser. No. 09/969,922, attorney docket no. 25791.69, filed on Oct. 3, 2001, which is a continuation-in-part application of U.S. Pat. No. 6,328,113, which was filed as U.S. patent application Ser. No. 09/440,338, attorney docket number 25791.9.02, filed on Nov. 15, 1999, which claims priority from provisional application 60/108,558, filed on Nov. 16, 1998, (48) PCT application US 03/00609, filed on Jan. 9, 2003, attorney docket no. 25791.71.02, which claims priority from U.S. provisional patent application Ser. No. 60/357,372, attorney docket no. 25791.71, filed on Feb. 15, 2002, (49) U.S. patent application Ser. No. 10/074,703, attorney docket no. 25791.74, filed on Feb. 12, 2002, which is a divisional of U.S. Pat. No. 6,568,471, which was filed as patent application Ser. No. 09/512,895, attorney docket no. 25791.12.02, filed on Feb. 24, 2000, which claims priority from provisional application 60/121,841, filed on Feb. 26, 1999, (50) U.S. patent application Ser. No. 10/074,244, attorney docket no. 25791.75, filed on Feb. 12, 2002, which is a divisional of U.S. Pat. No. 6,568,471, which was filed as patent application Ser. No. 09/512,895, attorney docket no. 25791.12.02, filed on Feb. 24, 2000, which claims priority from provisional application 60/121,841, filed on Feb. 26, 1999, (51) U.S. patent application Ser. No. 10/076,660, attorney docket no. 25791.76, filed on Feb. 15, 2002, which is a divisional of U.S. Pat. No. 6,568,471, which was filed as patent application Ser. No. 09/512,895, attorney docket no. 25791.12.02, filed on Feb. 24, 2000, which claims priority from provisional application 60/121,841, filed on Feb. 26, 1999, (52) U.S. patent application Ser. No. 10/076,661, attorney docket no. 25791.77, filed on Feb. 15, 2002, which is a divisional of U.S. Pat. No. 6,568,471, which was filed as patent application Ser. No. 09/512,895, attorney docket no. 25791.12.02, filed on Feb. 24, 2000, which claims priority from provisional application 60/121,841, filed on Feb. 26, 1999, (53) U.S. patent application Ser. No. 10/076,659, attorney docket no. 25791.78, filed on Feb. 15, 2002, which is a divisional of U.S. Pat. No. 6,568,471, which was filed as patent application Ser. No. 09/512,895, attorney docket no. 25791.12.02, filed on Feb. 24, 2000, which claims priority from provisional application 60/121,841, filed on Feb. 26, 1999, (54) U.S. patent application Ser. No. 10/078,928, attorney docket no. 25791.79, filed on Feb. 20, 2002, which is a divisional of U.S. Pat. No. 6,568,471, which was filed as patent application Ser. No. 09/512,895, attorney docket no. 25791.12.02, filed on Feb. 24, 2000, which claims priority from provisional application 60/121,841, filed on Feb. 26, 1999, (55) U.S. patent application Ser. No. 10/078,922, attorney docket no. 25791.80, filed on Feb. 20, 2002, which is a divisional of U.S. Pat. No. 6,568,471, which was filed as patent application Ser. No. 09/512,895, attorney docket no. 25791.12.02, filed on Feb. 24, 2000, which claims priority from provisional application 60/121,841, filed on Feb. 26, 1999, (56) U.S. patent application Ser. No. 10/078,921, attorney docket no. 25791.81, filed on Feb. 20, 2002, which is a divisional of U.S. Pat. No. 6,568,471, which was filed as patent application Ser. No. 09/512,895, attorney docket no. 25791.12.02, filed on Feb. 24, 2000, which claims priority from provisional application 60/121,841, filed on Feb. 26, 1999, (57) U.S. patent application Ser. No. 10/261,928, attorney docket no. 25791.82, filed on Oct. 1, 2002, which is a divisional of U.S. Pat. No. 6,557,640, which was filed as patent application Ser. No. 09/588,946, attorney docket no. 25791.17.02, filed on Jun. 7, 2000, which claims priority from provisional application 60/137,998, filed on Jun. 7, 1999, (58) U.S. patent application Ser. No. 10/079,276, attorney docket no. 25791.83, filed on Feb. 20, 2002, which is a divisional of U.S. Pat. No. 6,568,471, which was filed as patent application Ser. No. 09/512,895, attorney docket no. 25791.12.02, filed on Feb. 24, 2000, which claims priority from provisional application 60/121,841, filed on Feb. 26, 1999, (59) U.S. patent application Ser. No. 10/262,009, attorney docket no. 25791.84, filed on Oct. 1, 2002, which is a divisional of U.S. Pat. No. 6,557,640, which was filed as patent application Ser. No. 09/588,946, attorney docket no. 25791.17.02, filed on Jun. 7, 2000, which claims priority from provisional application 60/137,998, filed on Jun. 7, 1999, (60) U.S. patent application Ser. No. 10/092,481, attorney docket no. 25791.85, filed on Mar. 7, 2002, which is a divisional of U.S. Pat. No. 6,568,471, which was filed as patent application Ser. No. 09/512,895, attorney docket no. 25791.12.02, filed on Feb. 24, 2000, which claims priority from provisional application 60/121,841, filed on Feb. 26, 1999, (61) U.S. patent application Ser. No. 10/261,926, attorney docket no. 25791.86, filed on Oct. 1, 2002, which is a divisional of U.S. Pat. No. 6,557,640, which was filed as patent application Ser. No. 09/588,946, attorney docket no. 25791.17.02, filed on Jun. 7, 2000, which claims priority from provisional application 60/137,998, filed on Jun. 7, 1999, (62) PCT application US 02/36157, filed on Nov. 12, 2002, attorney docket no. 25791.87.02, which claims priority from U.S. provisional patent application Ser. No. 60/338,996, attorney docket no. 25791.87, filed on Nov. 12, 2001, (63) PCT application US 02/36267, filed on Nov. 12, 2002, attorney docket no. 25791.88.02, which claims priority from U.S. provisional patent application Ser. No. 60/339,013, attorney docket no. 25791.88, filed on Nov. 12, 2001, (64) PCT application US 03/11765, filed on Apr. 16, 2003, attorney docket no. 25791.89.02, which claims priority from U.S. provisional patent application Ser. No. 60/383,917, attorney docket no. 25791.89, filed on May 29, 2002, (65) PCT application US 03/15020, filed on May 12, 2003, attorney docket no. 25791.90.02, which claims priority from U.S. provisional patent application Ser. No. 60/391,703, attorney docket no. 25791.90, filed on Jun. 26, 2002, (66) PCT application US 02/39418, filed on Dec. 10, 2002, attorney docket no. 25791.92.02, which claims priority from U.S. provisional patent application Ser. No. 60/346,309, attorney docket no. 25791.92, filed on Jan. 7, 2002, (67) PCT application US 03/06544, filed on Mar. 4, 2003, attorney docket no. 25791.93.02, which claims priority from U.S. provisional patent application Ser. No. 60/372,048, attorney docket no. 25791.93, filed on Apr. 12, 2002, (68) U.S. patent application Ser. No. 10/331,718, attorney docket no. 25791.94, filed on Dec. 30, 2002, which is a divisional U.S. patent application Ser. No. 09/679,906, filed on Oct. 5, 2000, attorney docket no. 25791.37.02, which claims priority from provisional patent application Ser. No. 60/159,033, attorney docket no. 25791.37, filed on Oct. 12, 1999, (69) PCT application US 03/04837, filed on Feb. 29, 2003, attorney docket no. 25791.95.02, which claims priority from U.S. provisional patent application Ser. No. 60/363,829, attorney docket no. 25791.95, filed on Mar. 13, 2002, (70) U.S. patent application Ser. No. 10/261,927, attorney docket no. 25791.97, filed on Oct. 1, 2002, which is a divisional of U.S. Pat. No. 6,557,640, which was filed as patent application Ser. No. 09/588,946, attorney docket no. 25791.17.02, filed on Jun. 7, 2000, which claims priority from provisional application 60/137,998, filed on Jun. 7, 1999, (71) U.S. patent application Ser. No. 10/262,008, attorney docket no. 25791.98, filed on Oct. 1, 2002, which is a divisional of U.S. Pat. No. 6,557,640, which was filed as patent application Ser. No. 09/588,946, attorney docket no. 25791.17.02, filed on Jun. 7, 2000, which claims priority from provisional application 60/137,998, filed on Jun. 7, 1999, (72) U.S. patent application Ser. No. 10/261,925, attorney docket no. 25791.99, filed on Oct. 1, 2002, which is a divisional of U.S. Pat. No. 6,557,640, which was filed as patent application Ser. No. 09/588,946, attorney docket no. 25791.17.02, filed on Jun. 7, 2000, which claims priority from provisional application 60/137,998, filed on Jun. 7, 1999, (73) U.S. patent application Ser. No. 10/199,524, attorney docket no. 25791.100, filed on Jul. 19, 2002, which is a continuation of U.S. Pat. No. 6,497,289, which was filed as U.S. patent application Ser. No. 09/454,139, attorney docket no. 25791.03.02, filed on Dec. 3, 1999, which claims priority from provisional application 60/111,293, filed on Dec. 7, 1998, (74) PCT application US 03/10144, filed on Mar. 28, 2003, attorney docket no. 25791.101.02, which claims priority from U.S. provisional patent application Ser. No. 60/372,632, attorney docket no. 25791.101, filed on Apr. 15, 2002, (75) U.S. provisional patent application Ser. No. 60/412,542, attorney docket no. 25791.102, filed on Sep. 20, 2002, (76) PCT application US 03/14153, filed on May 6, 2003, attorney docket no. 25791.104.02, which claims priority from U.S. provisional patent application Ser. No. 60/380,147, attorney docket no. 25791.104, filed on May 6, 2002, (77) PCT application US 03/19993, filed on Jun. 24, 2003, attorney docket no. 25791.106.02, which claims priority from U.S. provisional patent application Ser. No. 60/397,284, attorney docket no. 25791.106, filed on Jul. 19, 2002, (78) PCT application US 03/13787, filed on May 5, 2003, attorney docket no. 25791.107.02, which claims priority from U.S. provisional patent application Ser. No. 60/387,486, attorney docket no. 25791.107, filed on Jun. 10, 2002, (79) PCT application US 03/18530, filed on Jun. 11, 2003, attorney docket no. 25791.108.02, which claims priority from U.S. provisional patent application Ser. No. 60/387,961, attorney docket no. 25791.108, filed on Jun. 12, 2002, (80) PCT application US 03/20694, filed on Jul. 1, 2003, attorney docket no. 25791.110.02, which claims priority from U.S. provisional patent application Ser. No. 60/398,061, attorney docket no. 25791.110, filed on Jul. 24, 2002, (81) PCT application US 03/20870, filed on Jul. 2, 2003, attorney docket no. 25791.111.02, which claims priority from U.S. provisional patent application Ser. No. 60/399,240, attorney docket no. 25791.111, filed on Jul. 29, 2002, (82) U.S. provisional patent application Ser. No. 60/412,487, attorney docket no. 25791.112, filed on Sep. 20, 2002, (83) U.S. provisional patent application Ser. No. 60/412,488, attorney docket no. 25791.114, filed on Sep. 20, 2002, (84) U.S. patent application Ser. No. 10/280,356, attorney docket no. 25791.115, filed on Oct. 25, 2002, which is a continuation of U.S. Pat. No. 6,470,966, which was filed as patent application Ser. No. 09/850,093, filed on May 7, 2001, attorney docket no. 25791.55, as a divisional application of U.S. Pat. No. 6,497,289, which was filed as U.S. patent application Ser. No. 09/454,139, attorney docket no. 25791.03.02, filed on Dec. 3, 1999, which claims priority from provisional application 60/111,293, filed on Dec. 7, 1998, (85) U.S. provisional patent application Ser. No. 60/412,177, attorney docket no. 25791.117, filed on Sep. 20, 2002, (86) U.S. provisional patent application Ser. No. 60/412,653, attorney docket no. 25791.118, filed on Sep. 20, 2002, (87) U.S. provisional patent application Ser. No. 60/405,610, attorney docket no. 25791.119, filed on Aug. 23, 2002, (88) U.S. provisional patent application Ser. No. 60/405,394, attorney docket no. 25791.120, filed on Aug. 23, 2002, (89) U.S. provisional patent application Ser. No. 60/412,544, attorney docket no. 25791.121, filed on Sep. 20, 2002, (90) PCT application US 03/24779, filed on Aug. 8, 2003, attorney docket no. 25791.125.02, which claims priority from U.S. provisional patent application Ser. No. 60/407,442, attorney docket no. 25791.125, filed on Aug. 30, 2002, (91) U.S. provisional patent application Ser. No. 60/423,363, attorney docket no. 25791.126, filed on Dec. 10, 2002, (92) U.S. provisional patent application Ser. No. 60/412,196, attorney docket no. 25791.127, filed on Sep. 20, 2002, (93) U.S. provisional patent application Ser. No. 60/412,187, attorney docket no. 25791.128, filed on Sep. 20, 2002, (94) U.S. provisional patent application Ser. No. 60/412,371, attorney docket no. 25791.129, filed on Sep. 20, 2002, (95) U.S. patent application Ser. No. 10/382,325, attorney docket no. 25791.145, filed on Mar. 5, 2003, which is a continuation of U.S. Pat. No. 6,557,640, which was filed as patent application Ser. No. 09/588,946, attorney docket no. 25791.17.02, filed on Jun. 7, 2000, which claims priority from provisional application 60/137,998, filed on Jun. 7, 1999, (96) U.S. patent application Ser. No. 10/624,842, attorney docket no. 25791.151, filed on Jul. 22, 2003, which is a divisional of U.S. patent application Ser. No. 09/502,350, attorney docket no. 25791.8.02, filed on Feb. 10, 2000, which claims priority from provisional application 60/119,611, filed on Feb. 11, 1999, (97) U.S. provisional patent application Ser. No. 60/431,184, attorney docket no. 25791.157, filed on Dec. 5, 2002, (98) U.S. provisional patent application Ser. No. 60/448,526, attorney docket no. 25791.185, filed on Feb. 18. 2003, (99) U.S. provisional patent application Ser. No. 60/461,539, attorney docket no. 25791.186, filed on Apr. 9, 2003, (100) U.S. provisional patent application Ser. No. 60/462,750, attorney docket no. 25791.193, filed on Apr. 14, 2003, (101) U.S. provisional patent application Ser. No. 60/436,106, attorney docket no. 25791.200, filed on Dec. 23, 2002, (102) U.S. provisional patent application Ser. No. 60/442,942, attorney docket no. 25791.213, filed on Jan. 27, 2003, (103) U.S. provisional patent application Ser. No. 60/442,938, attorney docket no. 25791.225, filed on Jan. 27, 2003, (104) U.S. provisional patent application Ser. No. 60/418,687, attorney docket no. 25791.228, filed on Apr. 18, 2003, (105) U.S. provisional patent application Ser. No. 60/454,896, attorney docket no. 25791.236, filed on Mar. 14, 2003, (106) U.S. provisional patent application Ser. No. 60/450,504, attorney docket no. 25791.238, filed on Feb. 26, 2003, (107) U.S. provisional patent application Ser. No. 60/451,152, attorney docket no. 25791.239, filed on Mar. 9, 2003, (108) U.S. provisional patent application Ser. No. 60/455,124, attorney docket no. 25791.241, filed on Mar. 17, 2003, (109) U.S. provisional patent application Ser. No. 60/453,678, attorney docket no. 25791.253, filed on Mar. 11, 2003, (110) U.S. patent application Ser. No. 10/421,682, attorney docket no. 25791.256, filed on Apr. 23, 2003, which is a continuation of U.S. patent application Ser. No. 09/523,468, attorney docket no. 25791.11.02, filed on Mar. 10, 2000, which claims priority from provisional application 60/124,042, filed on Mar. 11, 1999, (111) U.S. provisional patent application Ser. No. 60/457,965, attorney docket no. 25791.260, filed on Mar. 27, 2003, (112) U.S. provisional patent application Ser. No. 60/455,718, attorney docket no. 25791.262, filed on Mar. 18, 2003, (113) U.S. Pat. No. 6,550,821, which was filed as patent application Ser. No. 09/811,734, filed on Mar. 19, 2001, (114) U.S. patent application Ser. No. 10/436,467, attorney docket no. 25791.268, filed on May 12, 2003, which is a continuation of U.S. Pat. No. 6,604,763, which was filed as application Ser. No. 09/559,122, attorney docket no. 25791.23.02, filed on 4/26/2000, which claims priority from provisional application 60/131,106, filed on Apr. 26, 1999, (115) U.S. provisional patent application Ser. No. 60/459,776, attorney docket no. 25791.270, filed on Apr. 2, 2003, (116) U.S. provisional patent application Ser. No. 60/461,094, attorney docket no. 25791.272, filed on Apr. 8, 2003, (117) U.S. provisional patent application Ser. No. 60/461,038, attorney docket no. 25791.273, filed on Apr. 7, 2003, (118) U.S. provisional patent application Ser. No. 60/463,586, attorney docket no. 25791.277, filed on Apr. 17, 2003, (119) U.S. provisional patent application Ser. No. 60/472,240, attorney docket no. 25791.286, filed on May 20, 2003, (120) U.S. patent application Ser. No. 10/619,285, attorney docket no. 25791.292, filed on Jul. 14, 2003, which is a continuation-in-part of U.S. utility patent application Ser. No. 09/969,922, attorney docket no. 25791.69, filed on Oct. 3, 2001, which is a continuation-in-part application of U.S. Pat. No. 6,328,113, which was filed as U.S. patent application Ser. No. 09/440,338, attorney docket number 25791.9.02, filed on Nov. 15, 1999, which claims priority from provisional application 60/108,558, filed on Nov. 16, 1998, (121) U.S. utility patent application Ser. No. 10/418,688, attorney docket no. 25791.257, which was filed on Apr. 18, 2003, as a division of U.S. utility patent application Ser. No. 09/523,468, attorney docket no. 25791.11.02, filed on Mar. 10, 2000, which claims priority from provisional application 60/124,042, filed on Mar. 11, 1999, (122) PCT patent application serial no. PCT/US04/06246, attorney docket no. 25791.238.02, filed on Feb. 26, 2004, (123) PCT patent application serial number PCT/US04/08170, attorney docket number 25791.40.02, filed on Mar. 15, 2004, (124) PCT patent application serial number PCT/US04/08171, attorney docket number 25791.236.02, filed on Mar. 15, 2004, (125) PCT patent application serial number PCT/US04/08073, attorney docket number 25791.262.02, filed on Mar. 18, 2004, (126) PCT patent application serial number PCT/US04/07711, attorney docket number 25791.253.02, filed on Mar. 11, 2004, (127) PCT patent application serial number PCT/US04/009434, attorney docket number 25791.260.02, filed on Mar. 26, 2004, (128) PCT patent application serial number PCT/US04/010317, attorney docket number 25791.270.02, filed on Apr. 2, 2004, (129) PCT patent application serial number PCT/US04/010712, attorney docket number 25791.272.02, filed on Apr. 7, 2004, (130) PCT patent application serial number PCT/US04/010762, attorney docket number 25791.273.02, filed on Apr. 6, 2004, (131) PCT patent application serial number PCT/US04/011973, attorney docket number 25791.277.02, filed on Apr. 15, 2004, (132) U.S. provisional patent application Ser. No. 60/495056, attorney docket number 25791.301, filed on Aug. 14, 2003, (133) U.S. provisional patent application Ser. No. 60/600,679, attorney docket number 25791.194, filed on Aug. 11, 2004, (134) U.S. provisional patent application Ser. No. 60/500,435 attorney docket number 25791.304, filed on Sep. 5, 2003, (134) PCT patent application serial number PCT/US2005/027318, attorney docket number 25791.329.02, filed on Jul. 29, 2005; (135) PCT patent application serial number PCT/US2005/028936, attorney docket number 25791.338.02, filed on Aug. 12, 2005; (136) PCT patent application serial number PCT/US2005/028669, attorney docket number 25791.194.02, filed on Aug. 11, 2005; (137) PCT patent application serial number PCT/US2005/028453, attorney docket number 25791.371, filed on Aug. 11, 2005; (138) PCT patent application serial number PCT/US2005/028641, attorney docket number 25791.372, filed on Aug. 11, 2005; (139) PCT patent application serial number PCT/US2005/028819, attorney docket number 25791.373, filed on Aug. 11, 2005; (140) PCT patent application serial number PCT/US2005/028446, attorney docket number 25791.374, filed on Aug. 11, 2005; (141) PCT patent application serial number PCT/US2005/028642, attorney docket number 25791.375, filed on Aug. 11, 2005; (142) PCT patent application serial number PCT/US2005/028451, attorney docket number 25791.376, filed on Aug. 11, 2005, and (143). PCT patent application serial number PCT/US2005/028473, attorney docket number 25791.377, filed on Aug. 11, 2005, the disclosures of which are incorporated herein by reference. In an exemplary embodiment, the lubricating substrate 200 dries and adheres to the inner surface 304 of expandable tubular member 300, resulting in the capsules 100 being held adjacent the inner surface 304.

Referring now to FIGS. 4a and 4e, the method 400 proceeds to step 406 where a conventional expansion device 406a is positioned in the expandable tubular member 300. The expandable tubular member 300 may be positioned in a well bore 406b and the expansion device 300 may be positioned in the passageway 302 of the expandable tubular member 300 and in engagement with the lubricating substrate 200 and the inner surface 304 of the expandable tubular member 300. The expansion device 406a has an increasing diameter along its length such that a front end of the expansion device has a diameter substantially equal to the inner diameter A of the expandable tubular member 300 and the rear end has a diameter B which is greater than the diameter A. In several exemplary embodiments, the expansion device may include any number of conventional expansion devices in which the device engages the inner surface of the tubular member during expansion such as, for example, rotary expansion devices or other equivalent expansion devices known in the art.

Referring now to FIGS. 4a, 4e, and 4f, the method 400 proceeds to step 408 where the expansion device 406a is moved axially in a direction C through the expandable tubular member 300. As the expansion device 406a moves through the expandable tubular member 300, engagement of the expansion device 406a and the inner surface 304 causes the expandable tubular member 300 to expand from the inner diameter A to an inner diameter substantially equal to the diameter B of expansion device 406a. During expansion of the expandable tubular member 300 by the expansion device 406a, the lubricating substrate 200 reduces friction between the expansion device 406a and the expandable tubular member 300. In addition, as the expansion device 406a expands the expandable tubular member 300, the capsules 100 are ruptured between the expansion device 406a and the inner surface 304 and opened, releasing the lubricating material 104 between the expansion device 406a and the inner surface 304. As the expansion device 406a continues through the passageway 302 in expandable tubular member 300, the lubricating material 104 is allowed to flow in front of the expansion device 406a and between the expansion device 406a and the inner surface 304. As a result, the lubricating material 104 is selectively released to provide additional lubrication for the expandable tubular member 300.

When selecting a lubricating material 104 for the method 400 for lubricating the interface between the expansion device 406 and the expandable tubular member 300 during the expansion process, the lubricating material 104 may be any media that may assist in reducing the friction between the expansion device 406a and the expandable tubular member 300, including any fluidic material. Several factors may be considered, including the coefficient of friction between the expansion device 406a and the expandable tubular member 300, the size and complexity of the expansion device 406a, and the length of the expandable tubular member 300. The lubricating material 104 may include wet lubricants and/or solid lubricants. It is expected that the lubricating material 104 typically needs to withstand at least 5000 psi of pressure.

In an exemplary embodiment, the lubricating material 104 for the method 400 for lubricating the interface between the expansion device 406 and the expandable tubular member 300 during the expansion process may include, for example, conventional commercial lubricants (natural and synthetic), working hydraulic fluid mud currently used in expandable tubular systems, and working hydraulic fluid mud blended with solid lubricants to improve lubricity. In an exemplary embodiment, a lithium based (non-synthetic) multipurpose grease combined with a solid lubricant may be used as the lubricant. In an exemplary embodiment, a grease lubricant for this application may be composed of a solid lubricant in a moderately high temperature resistant thickener. In an exemplary embodiment, the lubricant may have at least 10% Graphite or 10% Molybdenum Disulfide in a thickener with a dropping point above 350-400 F. In an exemplary embodiment, lubricating material 104 used in method 400 may include any or all of the following:

| Lubricant Name | Manufacturer | Composition | Supplier |
|---|---|---|---|
| 339-S Graphite Grease | Dixon Lube | 30% Graphite | Dixon Lubricants and Specialty |
| | | | Products, Asbury, New Jersey |
| #3HT Moli-Grease | Bemol | 15% Molybdenum | The Rose Mill Company, |
| | | | East Harford, Connecticut |

Exemplary embodiments of the lubricating material 104 for the method 400 for lubricating the interface between the expansion device 406 and the expandable tubular member 300 during the expansion process may consist of the following component in the weight percentages indicated:

| | Weight | | |
|---|---|---|---|
| Component | Percentage | Characteristic | Examples |
| 1 | 64.25-90.89% | Base oil | A natural triglyceride oil which is, such as for |
| | | | example, fish, animal or vegetable triglyceride |
| | | | oil, or mixtures thereof. The triglyceride oil is a |
| | | | vegetable triglyceride oil, such as for example, |
| | | | sunflower seed oil, soybean oil, rapeseed oil |
| | | | canola oil, palm nut oil, palm oil, olive oil, |
| | | | rapeseed oil, canola oil, linseed oil, ground nut |
| | | | oil, soybean oil, cottonseed oil, sunflower seed |
| | | | oil, pumpkin seed oil, coconut oil, corn oil, castor |
| | | | oil, walnut oil and mixtures thereof. |
| | | | A natural or synthetic oil, which may be an ester |
| | | | wherein unsaturation as above triglycerides. |
| | | | The ester may be formed by a transesterification |
| | | | reaction of suitable monobasic and/or dibasic |
| | | | organic acids with primary, secondary or tertiary |
| | | | alcohols. An example of such a naturally |
| | | | occurring ester is jojoba oil and such a synthetic |
| | | | ester is lauryl oleate. |
| | | | The ester mentioned above may be formed by |
| | | | the reaction of unsaturated acids with polyhydric |
| | | | alcohols, such as for example, neopentyl glycol, |
| | | | trimethylolylethane, trimethylolpropane or |
| | | | pentaerythritol. Examples of such a reaction |
| | | | product are pentaerythritol monooleate, |
| | | | dioleate, trioleate, and the like. |
| | | | Example commercially available products are as |
| | | | follows: Canola oil from Cargil Inc(Agri-Pure 60, |
| | | | Agri-Pure -85) or Lambent (Oleocal 102); and |
| | | | Sunflower oil (Lubrizol 7631) |
| 2 | 0.02-0.05% | Metal | Triazol and benzotriazol derivatives, such as for |
| | | deactivator | example, tolyltriazol. |
| | | | Example commercially available products are as |
| | | | follows: Tolyltriazole, from PMC Inc (Cobratec |
| | | | TT-100); and 1H-Benzotriazole-1-Methanamine, |
| | | | N-N-bis(2-ethylhexyl)-methyl, from |
| | | | Ciba-Geigy Corp (Reomet 39) |
| 3 | 0.5-3.0% | Antioxidants | Aromatic amine antioxidants and/or hindered |
| | | | phenolic antioxidants antioxidants, such as for |
| | | | example, 2,6-bis (tert butyl-4-methylphenol, |
| | | | BHT). |
| | | | Example commercially available products are as |
| | | | follows: Octylated, Butylated Diphenylamine |
| | | | Antioxidant from Ciba-Geigy Corp (Irganox L |
| | | | 57); 2,6-bis (1,1-dimethylethyl)-4-methyl- |
| | | | Phenol, from PMC, Inc (BHT); and |
| | | | Benzenepropanoic acid, 3,5-bis (1,1-demethylethyl)- |
| | | | 4-hydroxy-, thiodi-2, 1-ethanediyl |
| | | | ester, from Ciba-Geigy Corp (Irganox 1035); |
| 4 | 4-12% | Sulfurized | Sulfurized vegetable or animal fatty oils, with |
| | | natural oils | sulfur content 9%-21%, such as for example |
| | | | 13.5%-17.5%. |
| | | | Example commercially available products are as |
| | | | follows: Sulfurized vegetable oils from Rhein |
| | | | Chemie Corporation (Additin RC-2515); and |
| | | | Sulfurized Lard Oil from Ferro Corporation (HSL). |
| 5 | 4-12% | Phosphate | Phosphoric acid esters with ethoxylated fatty |
| | | ester | (C12-C15) alcohols, preferably mixture of |
| | | | phosphoric acid ester with ethoxylated lauryl |
| | | | alcohol and phosphoric acid ester with |
| | | | ethoxylated tridecyl alcohol. |
| | | | Example commercially available products are as |
| | | | follows: Phosphoric acid ester with ethoxylated |
| | | | lauryl alcohol and phosphoric acid ester with |
| | | | ethoxylated tridecyl alcohol from Houghton |
| | | | international (Houghton 5653). |
| 6 | 0.4-1.5% | Phosphoric | Phosphoric acid. |
| | | acid | An example commercially available product is |
| | | | phosphoric acid from Rhodia. |
| 7 | 0.08-1.5% | Viscosity | Polyacrylates, polymethacrylates, |
| | | modifier | vinylpyrrolidone/methacrylate-copolymers, |
| | | | polyvinylpyrrolidones, polybutanes, olefin- |
| | | | copolymers, styrene/-acrylate-copolymers, |
| | | | polyethers, such as for example, styrene or |
| | | | butadiene-styrene polymer. |
| | | | An example commercially available product is |
| | | | Styrene Hydrocarbon Polymer from Lubrizol |
| | | | Corporation (Lubrizol ® 7440S). |
| 8 | 0.1-0.5% | Pour-point | Polymethacrylates, alkylated naphthalene |
| | | depressant | derivatives, such as for example, alkyl ester |
| | | | copolymers. |
| | | | An example commercially available product is |
| | | | Alkyl ester copolymer from Lubrizol Corporation |
| | | | (Lubrizol 6662) |
| 9 | 0.01-0.2% | Defoamer | Silicon based antifoam agent. |
| | | | An example commercially available product is |
| | | | Silicon based antifoam agent from Ultra |
| | | | Additives (Foam Ban 103) |
| 10 | 0-5% | Carboxylic | Alkali, alkanolamine, alkyl amine or alkoxylated |
| | | acid soaps | amine salts of mono- or dibasic fatty acids, or |
| | | | mixture thereof. |
| | | | An example commercially available product is |
| | | | Soap formed in situ as a product of reaction |
| | | | between Tall Oil Fatty Acids (Sylvatal ® D30LR |
| | | | from Arizona Chemical Co.) and triethanol |
| | | | amine (TEA 99 from Huntsman Corporation) |

The lubricating material 104 may optionally contain various other additives, or mixture thereof, in order to improve the basic properties. In an exemplary embodiment, these further additives may include other antioxidants, metal deactivators, viscosity improvers, extreme-pressure additives, pour-point depressants, antifoam agents, dispersants, detergents, corrosion inhibitors, emulsifiers, demulsifiers and friction modifiers.

Exemplary experiments have shown that the lubricating material 104 identified in the table below, H1, H2, H3, H4, H5, H6, and H7, identified by the specified components in the weight percentages and the component manufactures and/or distributors indicated may perform in a system for lubricating the interface between an expansion cone and a tubular member:

| | | Manufacture/ | Example Lubricants | | | | | | |
|---|---|---|---|---|---|---|---|---|---|
| Component | | Distributor | H1 | H2 | H3 | H4 | H5 | H6 | H7 |
| 1 | Canola oil | Agri-Pure 60 | 77.81% | 64.25% | 90.89% | 68.71% | 82.07% | 80.68% | 80.31% |
| 2 | Tolyltriazole | Cobratec TT-100 | 0.04% | 0.05% | 0.02% | 0.04% | 0.03% | 0.04% | 0.04% |
| 3 | Aminic antioxidant | Irganox L 57 | 0 | 1% | 0 | 0.5% | 0.5% | 0 | 0 |
| | Phenolic antioxidant | BHT | 1.0% | 2% | 0.5% | 1% | 0.5% | 1% | 1.1% |
| 4 | Sulfurized vegetable oil Or | Additin RC-2515 | 10% | 12% | 4% | 12% | | | 9% |
| | Sulfurized lard oil | HSL | | | | | 10% | 8% | |
| 5 | Phosphoric acid ester with | Rhodofac RS 410 + | 9% | 12% | 4% | 10% | 5% | 9% | 8% |
| | ethoxylated lauryl alcohol | Rhodofac PC 100 | | | | | | | |
| | and phosphoric acid ester | | | | | | | | |
| | with ethoxylated tridecyl | | | | | | | | |
| | alcohol | | | | | | | | |
| 6 | Phosphoric acid | Phosphoric acid | 1% | 1.5% | 0.4% | 1.1% | 0.5% | 1% | 0.8% |
| 7 | Styrene Hydrocarbon Polymer | Lubrizol 7440S | 0.8% | 1.5% | 0.08% | 1.5% | 0.1% | 0.1% | 0.4% |
| 8 | Alkyl ester copolymer | Lubrizol 6662 | 0.3% | 0.5% | 0.1% | 0.1% | 0.2% | 0.1% | 0.3% |
| 9 | Silicon based antifoam agent | Foam Ban 103 | 0.05% | 0.2% | 0.01% | 0.05 | 0.1% | 0.08% | 0.05% |
| 10 | Carboxylic acid soap | Sylvatal ® D30LR + | 0 | 5% | 0 | 5% | 1% | 0 | 0 |
| | | TEA 99 | | | | | | | |

A lubricant has been described that includes a lubricating substrate and a plurality of capsules in the lubricating substrate, the plurality of capsules containing a lubricating material. In an exemplary embodiment, the lubricating substrate comprises a dry film lubricant. In an exemplary embodiment, the plurality of capsules comprise a plurality of microcapsules. In an exemplary embodiment, the plurality of capsules comprise a plurality of nanocapsules. In an exemplary embodiment, the plurality of capsules comprise a semi-hard shell material. In an exemplary embodiment, the plurality of capsules are operable to open under pressure and release the lubricating material. In an exemplary embodiment, the plurality of capsules are dispersed throughout the lubricating substrate. In an exemplary embodiment, the lubricating material comprises an oil. In an exemplary embodiment, the lubricating substrate is operable to reduce friction on a surface while holding the plurality of capsules adjacent the surface. In an exemplary embodiment, the lubricating substrate is selected from the group consisting of 20%-26% Methyl Ethyl Ketone, 20%-25 % Titanium dioxide, 4-15% Polytetraflouro ethylene, 40-50% Alkyd Resin CAS, and combinations thereof. In an exemplary embodiment, the lubricating material is selected from the group consisting of 64.25-90.89% base oil, 0.02-0.05% metal deactivator, 0.5-3.0% antioxidants, 4-12%, sulfurized natural oils, 4-12% phosphate ester, 0.4-1.5% phosphoric acid, 0.08-1.5% viscosity modifier, 0.1-0.5% pour-point depressant, 0.01-0.2% defoamer, 0-5% carboxylic acid soaps, and combinations thereof. In an exemplary embodiment, the lubricating material is selected from the group consisting of H1, H2, H3, H4, H5, H6, H7, and combinations thereof.

A expandable tubular member has been described that includes a tubular member comprising an inner surface, a lubricating substrate coupled to the inner surface, and a plurality of capsules in the lubricating substrate, the plurality of capsules containing a lubricating material. In an exemplary embodiment, the lubricating substrate comprises a dry film lubricant. In an exemplary embodiment, the plurality of capsules comprise a plurality of microcapsules. In an exemplary embodiment, the plurality of capsules comprise a plurality of nanocapsules. In an exemplary embodiment, the plurality of capsules comprise a semi-hard shell material. In an exemplary embodiment, the plurality of capsules are operable to open under pressure and release the lubricating material adjacent the inner surface. In an exemplary embodiment, the plurality of capsules are dispersed throughout the lubricating substrate. In an exemplary embodiment, the lubricating material comprises an oil. In an exemplary embodiment, the lubricating substrate is operable to reduce friction on the inner surface while holding the plurality of capsules adjacent the inner surface. In an exemplary embodiment, an expansion device is positioned in the tubular member and adjacent the inner surface, the expansion device operable to open capsules to provide the lubricating material between the expansion device and the inner surface while the expansion device expands the tubular member. In an exemplary embodiment, the expandable tubular member is positioned in a well bore. In an exemplary embodiment, the tubular member is a wellbore casing. In an exemplary embodiment, the tubular member is a structural support. In an exemplary embodiment, the tubular member is a pipeline. In an exemplary embodiment, the lubricating substrate is selected from the group consisting of 20%-26% Methyl Ethyl Ketone, 20%-25 % Titanium dioxide, 4-15% Polytetraflouro ethylene, 40-50% Alkyd Resin CAS, and combinations thereof. In an exemplary embodiment, the lubricating material is selected from the group consisting of 64.25-90.89% base oil, 0.02-0.05% metal deactivator, 0.5-3.0% antioxidants, 4-12%, sulfurized natural oils, 4-12% phosphate ester, 0.4-1.5% phosphoric acid, 0.08-1.5% viscosity modifier, 0.1-0.5% pour-point depressant, 0.01-0.2% defoamer, 0-5% carboxylic acid soaps, and combinations thereof. In an exemplary embodiment, the lubricating material is selected from the group consisting of H1, H2, H3, H4, H5, H6, H7, and combinations thereof.

A expandable tubular member has been described that includes a tubular member comprising an inner surface, and means for selectively releasing a lubricating material adjacent the inner surface, the means for selectively releasing a lubricating material coupled to the inner surface. In an exemplary embodiment, the member further includes means for reducing friction on the inner surface and for coupling the means for selectively releasing a lubricating material to the inner surface, the means for reducing friction positioned on the inner surface. In an exemplary embodiment, the member further includes means for expanding the tubular member and for initiating the means for selectively releasing a lubricating material to release the lubricating material, the means for expanding positioned in the tubular member and adjacent the inner surface. In an exemplary embodiment, the tubular member is positioned in a well bore. In an exemplary embodiment, the tubular member is a wellbore casing. In an exemplary embodiment, the tubular member is a structural support. In an exemplary embodiment, the tubular member is a pipeline. In an exemplary embodiment, the means for reducing friction is selected from the group consisting of 20%-26% Methyl Ethyl Ketone, 20%-25% Titanium dioxide, 4-15% Polytetraflouro ethylene, 40-50% Alkyd Resin CAS, and combinations thereof. In an exemplary embodiment, the lubricating material is selected from the group consisting of 64.25-90.89% base oil, 0.02-0.05% metal deactivator, 0.5-3.0% antioxidants, 4-12%, sulfurized natural oils, 4-12% phosphate ester, 0.4-1.5% phosphoric acid, 0.08-1.5% viscosity modifier, 0.1-0.5% pour-point depressant, 0.01-0.2% defoamer, 0-5% carboxylic acid soaps, and combinations thereof. In an exemplary embodiment, the lubricating material is selected from the group consisting of H1, H2, H3, H4, H5, H6, H7, and combinations thereof.

A method for lubricating an expandable tubular member has been described that includes providing an tubular member comprising an inner surface, coupling a lubricating substrate to the inner surface, the lubricating substrate comprising a plurality of capsules containing a lubricating material, and selectively releasing the lubricating material adjacent the inner surface. In an exemplary embodiment, the coupling a lubricating substrate to the inner surface comprises applying a film of lubricant that dries to the inner surface. In an exemplary embodiment, the film of lubricant comprises the plurality of capsules. In an exemplary embodiment, the selectively releasing the lubricating material adjacent the inner surface comprises opening the capsules to release the lubricating material. In an exemplary embodiment, the selectively releasing the lubricating material adjacent the inner surface comprises expanding the tubular member with an expansion device, whereby the expansion device opens the capsules to release the lubricating material between the expansion device and the inner surface as the expansion device expands the tubular member. In an exemplary embodiment, the method further includes positioning the tubular member in a well bore. In an exemplary embodiment, the providing an tubular member comprises providing a wellbore casing. In an exemplary embodiment, the providing an tubular member comprises providing a structural support. In an exemplary embodiment, the providing an tubular member comprises providing a pipeline. In an exemplary embodiment, the lubricating substrate is selected from the group consisting of 20%-26% Methyl Ethyl Ketone, 20%-25% Titanium dioxide, 4-15% Polytetraflouro ethylene, 40-50% Alkyd Resin CAS, and combinations thereof. In an exemplary embodiment, the lubricating material is selected from the group consisting of 64.25-90.89% base oil, 0.02-0.05% metal deactivator, 0.5-3.0% antioxidants, 4-12%, sulfurized natural oils, 4-12% phosphate ester, 0.4-1.5% phosphoric acid, 0.08-1.5% viscosity modifier, 0.1-0.5% pour-point depressant, 0.01-0.2% defoamer, 0-5% carboxylic acid soaps, and combinations thereof. In an exemplary embodiment, the lubricating material is selected from the group consisting of H1, H2, H3, H4, H5, H6, H7, and combinations thereof.

A lubricant has been described that includes a dry film lubricant, and a plurality of microcapsules dispersed throughout the dry film lubricant and each comprising a semi-hard shelled material containing an oil, the semi-hard shelled material operable to open under pressure and release the oil. In an exemplary embodiment, the dry film lubricant is operable to reduce friction on a surface while holding the plurality of microcapsules adjacent the surface. In an exemplary embodiment, the dry film lubricant is selected from the group consisting of 20%-26% Methyl Ethyl Ketone, 20%-25% Titanium dioxide, 4-15% Polytetraflouro ethylene, 40-50% Alkyd Resin CAS, and combinations thereof. In an exemplary embodiment, the oil is selected from the group consisting of 64.25-90.89% base oil, 0.02-0.05% metal deactivator, 0.5-3.0% antioxidants, 4-12%, sulfurized natural oils, 4-12% phosphate ester, 0.4-1.5% phosphoric acid, 0.08-1.5% viscosity modifier, 0.1-0.5% pour-point depressant, 0.01-0.2% defoamer, 0-5% carboxylic acid soaps, and combinations thereof. In an exemplary embodiment, the oil is selected from the group consisting of H1, H2, H3, H4, H5, H6, H7, and combinations thereof.

A expandable tubular member has been described that includes a tubular member comprising an inner surface, a dry film lubricant coupled to the inner surface, and a plurality of microcapsules dispersed through the dry film lubricant and each comprising a semi-hard shelled material containing an oil, the semi-hard shelled material operable to open under pressure and release the oil. In an exemplary embodiment, the dry film lubricant is operable to reduce friction on the inner surface while holding the plurality of microcapsules adjacent the inner surface. In an exemplary embodiment, the member further includes an expansion device positioned in the tubular member and adjacent the inner surface, the expansion device operable to open the semi-hard shelled material to provide the lubricating material between the expansion device and the inner surface while the expansion device expands the tubular member. In an exemplary embodiment, the tubular member is positioned in a well bore. In an exemplary embodiment, the tubular member is a wellbore casing. In an exemplary embodiment, the tubular member is a structural support. In an exemplary embodiment, the tubular member is a pipeline. In an exemplary embodiment, the dry film lubricant is selected from the group consisting of 20%-26% Methyl Ethyl Ketone, 20%-25% Titanium dioxide, 4-15% Polytetraflouro ethylene, 40-50% Alkyd Resin CAS, and combinations thereof. In an exemplary embodiment, the oil is selected from the group consisting of 64.25-90.89% base oil, 0.02-0.05% metal deactivator, 0.5-3.0% antioxidants, 4-12%, sulfurized natural oils, 4-12% phosphate ester, 0.4-1.5% phosphoric acid, 0.08-1.5% viscosity modifier, 0.1-0.5% pour-point depressant, 0.01-0.2% defoamer, 0-5% carboxylic acid soaps, and combinations thereof. In an exemplary embodiment, the oil is selected from the group consisting of H1, H2, H3, H4, H5, H6, H7, and combinations thereof.

A expandable tubular member has been described that includes a tubular member comprising an inner surface, means for reducing friction on the inner surface coupled to the inner surface, and means for selectively releasing a lubricating material in the means for reducing friction on the inner surface. In an exemplary embodiment, the member further includes means for expanding the tubular member and for initiating the release of the lubricating material from the means for selectively releasing a lubricating material, the means for expanding positioned in the tubular member and adjacent the inner surface. In an exemplary embodiment, the tubular member is positioned in a well bore. In an exemplary embodiment, the means for reducing friction is selected from the group consisting of 20%-26% Methyl Ethyl Ketone, 20%-25% Titanium dioxide, 4-15% Polytetraflouro ethylene, 40-50% Alkyd Resin CAS, and combinations thereof. In an exemplary embodiment, the lubricating material is selected from the group consisting of 64.25-90.89% base oil, 0.02-0.05% metal deactivator, 0.5-3.0% antioxidants, 4-12%, sulfurized natural oils, 4-12% phosphate ester, 0.4-1.5% phosphoric acid, 0.08-1.5% viscosity modifier, 0.1-0.5% pour-point depressant, 0.01-0.2% defoamer, 0-5% carboxylic acid soaps, and combinations thereof. In an exemplary embodiment, the lubricating material is selected from the group consisting of H1, H2, H3, H4, H5, H6, H7, and combinations thereof.

A method for expanding an expandable tubular member has been described that includes providing a tubular member comprising an inner surface, applying a film of lubricant that dries to the inner surface, the film of lubricant comprising a plurality of microcapsules, the plurality of microcapsules each comprising a semi-hard shelled material containing an oil, positioning the tubular member in a well bore, expanding the tubular member by moving an expansion device through the tubular member, opening the semi-hard shelled material to release the oil between the expansion device and the inner surface as the expansion device moves through the tubular member.

It is understood that variations may be made in the foregoing without departing from the scope of the disclosed embodiments. Furthermore, the elements and teachings of the various illustrative embodiments may be combined in whole or in part some or all of the illustrated embodiments.

Although illustrative embodiments have been shown and described, a wide range of modification, change and substitution is contemplated in the foregoing disclosure and in some instances, some features of the embodiments may be employed without a corresponding use of other features. Accordingly, it is appropriate that the appended claims be construed broadly and in a manner consistent with the scope of the embodiments disclosed herein.

1. A lubricant for lubricating a surface of a solid member comprising:
a lubricating substrate coupled to the surface of the solid member; and
a plurality of capsules in the lubricating substrate, the plurality of capsules containing a lubricating material.

2. The lubricant of claim 1 wherein the lubricating substrate comprises a dry film lubricant.

3. The lubricant of claim 1 wherein the plurality of capsules comprise a plurality of microcapsules.

4. The lubricant of claim 1 wherein the plurality of capsules comprise a plurality of nanocapsules.

5. The lubricant of claim 1 wherein the plurality of capsules comprise a semi-hard shell material.

6. The lubricant of claim 1 wherein the plurality of capsules are operable to open under pressure and release the lubricating material.

7. The lubricant of claim 1 wherein the plurality of capsules are dispersed throughout the lubricating substrate.

8. The lubricant of claim 1 wherein the lubricating material comprises an oil.

9. The lubricant of claim 1 wherein the lubricating substrate is operable to reduce friction on a surface while holding the plurality of capsules adjacent the surface.

10. The lubricant of claim 1 wherein the lubricating substrate comprises 20%-26% Methyl Ethyl Ketone, 20%-25% Titanium dioxide, 4-15% Polytetraflouro ethylene, 40-50% Alkyd Resin CAS, and combinations thereof.

11. The lubricant of claim 1 wherein the lubricating material comprises 64.25-90.89% base oil, 0.02-0.05% metal deactivator, 0.5-3.0% antioxidants, 4-12%, sulfurized natural oils, 4-12% phosphate ester, 0.4-1.5% phosphoric acid, 0.08-1.5% viscosity modifier, 0.1-0.5% pour-point depressant, 0.01-0.2% defoamer, 0-5% carboxylic acid soaps, and combinations thereof.

12. The lubricant of claim 1 wherein the lubricating material is selected from the group consisting of H1, H2, H3, H4, H5, H6, H7, and combinations thereof.

13. An expandable tubular member comprising:
a tubular member comprising an inner surface;
a lubricating substrate coupled to the inner surface; and
a plurality of capsules in the lubricating substrate, the plurality of capsules containing a lubricating material.

14. The expandable tubular member of claim 13 wherein the lubricating substrate comprises a dry film lubricant.

15. The expandable tubular member of claim 13 wherein the plurality of capsules comprise a plurality of microcapsules.

16. The expandable tubular member of claim 13 wherein the plurality of capsules comprise a plurality of nanocapsules.

17. The expandable tubular member of claim 13 wherein the plurality of capsules comprise a semi-hard shell material.

18. The expandable tubular member of claim 13 wherein the plurality of capsules are operable to open under pressure and release the lubricating material adjacent the inner surface.

19. The expandable tubular member of claim 13 wherein the plurality of capsules are dispersed throughout the lubricating substrate.

20. The expandable tubular member of claim 13 wherein the lubricating material comprises an oil.

21. The expandable tubular member of claim 13 wherein the lubricating substrate is operable to reduce friction on the inner surface while holding the plurality of capsules adjacent the inner surface.

22. The expandable tubular member of claim 13 further comprising:
an expansion device positioned in the tubular member and adjacent the inner surface, the expansion device operable to open capsules to provide the lubricating material between the expansion device and the inner surface while the expansion device expands the tubular member.

23. The expandable tubular member of claim 13 wherein the expandable tubular member is positioned in a well bore.

24. The expandable tubular member of claim 13 wherein the tubular member is a wellbore casing.

25. The expandable tubular member of claim 13 wherein the tubular member is a structural support.

26. The expandable tubular member of claim 13 wherein the tubular member is a pipeline.

27. The expandable tubular member of claim 13 wherein the lubricating substrate comprises 20%-26% Methyl Ethyl Ketone, 20%-25% Titanium dioxide, 4-15% Polytetraflouro ethylene, 40-50% Alkyd Resin CAS, and combinations thereof.

28. The expandable tubular member of claim 13 wherein the lubricating material comprises 64.25-90.89% base oil, 0.02-0.05% metal deactivator, 0.5-3.0% antioxidants, 4-12%, sulfurized natural oils, 4-12% phosphate ester, 0.4-1.5% phosphoric acid, 0.08-1.5% viscosity modifier, 0.1-0.5% pour-point depressant, 0.01-0.2% defoamer, 0-5% carboxylic acid soaps, and combinations thereof.

29. The expandable tubular member of claim 13 wherein the lubricating material is selected from the group consisting of H1, H2, H3, H4, H5, H6, H7, and combinations thereof.

30. An expandable tubular member comprising:
a tubular member comprising an inner surface; and
means for selectively releasing a lubricating material adjacent the inner surface, the means for selectively releasing a lubricating material coupled to the inner surface.

31. The expandable tubular member of claim 30 further comprising:
means for reducing friction on the inner surface and for coupling the means for selectively releasing a lubricating material to the inner surface, the means for reducing friction positioned on the inner surface.

32. The expandable tubular member of claim 30 further comprising:
means for expanding the tubular member and for initiating the means for selectively releasing a lubricating material to release the lubricating material, the means for expanding positioned in the tubular member and adjacent the inner surface.

33. The expandable tubular member of claim 30 wherein the tubular member is positioned in a well bore.

34. The expandable tubular member of claim 30 wherein the tubular member is a wellbore casing.

35. The expandable tubular member of claim 30 wherein the tubular member is a structural support.

36. The expandable tubular member of claim 30 wherein the tubular member is a pipeline.

37. The expandable tubular member of claim 31 wherein the means for reducing friction comprises 20%-26% Methyl Ethyl Ketone, 20%-25% Titanium dioxide, 4-15% Polytetraflouro ethylene, 40-50% Alkyd Resin CAS, and combinations thereof.

38. The expandable tubular member of claim 30 wherein the lubricating material comprises 64.25-90.89% base oil, 0.02-0.05% metal deactivator, 0.5-3.0% antioxidants, 4-12%, sulfurized natural oils, 4-12% phosphate ester, 0.4-1.5% phosphoric acid, 0.08-1.5% viscosity modifier, 0.1-0.5% pour-point depressant, 0.01-0.2% defoamer, 0-5% carboxylic acid soaps, and combinations thereof.

39. The expandable tubular member of claim 30 wherein the lubricating material is selected from the group consisting of H1, H2, H3, H4, H5, H6, H7, and combinations thereof.

40. A method for lubricating an expandable tubular member comprising:
providing an tubular member comprising an inner surface;
coupling a lubricating substrate to the inner surface, the lubricating substrate comprising a plurality of capsules containing a lubricating material; and
selectively releasing the lubricating material adjacent the inner surface.

41. The method of claim 40 wherein the coupling a lubricating substrate to the inner surface comprises applying a film of lubricant that dries to the inner surface.

42. The method of claim 40 wherein the film of lubricant comprises the plurality of capsules.

43. The method of claim 40 wherein the selectively releasing the lubricating material adjacent the inner surface comprises opening the capsules to release the lubricating material.

44. The method of claim 40 wherein the selectively releasing the lubricating material adjacent the inner surface comprises expanding the tubular member with an expansion device, whereby the expansion device opens the capsules to release the lubricating material between the expansion device and the inner surface as the expansion device expands the tubular member.

45. The method of claim 40 further comprising:
positioning the tubular member in a well bore.

46. The method of claim 40 wherein the providing an tubular member comprises providing a wellbore casing.

47. The method of claim 40 wherein the providing an tubular member comprises providing a structural support.

48. The method of claim 40 wherein the providing an tubular member comprises providing a pipeline.

49. The method of claim 40 wherein the lubricating substrate comprises 20%-26% Methyl Ethyl Ketone, 20%-25% Titanium dioxide, 4-15% Polytetraflouro ethylene, 40-50% Alkyd Resin CAS, and combinations thereof.

50. The method of claim 40 wherein the lubricating material comprises 64.25-90.89% base oil, 0.02-0.05% metal deactivator, 0.5-3.0% antioxidants, 4-12%, sulfurized natural oils, 4-12% phosphate ester, 0.4-1.5% phosphoric acid, 0.08-1.5% viscosity modifier, 0.1-0.5% pour-point depressant, 0.01-0.2% defoamer, 0-5% carboxylic acid soaps, and combinations thereof.

51. The method of claim 40 wherein the lubricating material is selected from the group consisting of H1, H2, H3, H4, H5, H6, H7, and combinations thereof.

52. A lubricant comprising:
a dry film lubricant; and
a plurality of microcapsules dispersed throughout the dry film lubricant and each comprising a semi-hard shelled material containing an oil, the semi-hard shelled material operable to open under pressure and release the oil.

53. The lubricant of claim 52 wherein the dry film lubricant is operable to reduce friction on a surface while holding the plurality of microcapsules adjacent the surface.

54. The lubricant of claim 52 wherein the dry film lubricant comprises 20%-26% Methyl Ethyl Ketone, 20%-25% Titanium dioxide, 4-15% Polytetraflouro ethylene, 40-50% Alkyd Resin CAS, and combinations thereof.

55. The lubricant of claim 52 wherein the oil comprises 64.25-90.89% base oil, 0.02-0.05% metal deactivator, 0.5-3.0% antioxidants, 4-12%, sulfurized natural oils, 4-12% phosphate ester, 0.4-1.5% phosphoric acid, 0.08-1.5% viscosity modifier, 0.1-0.5% pour-point depressant, 0.01-0.2% defoamer, 0-5% carboxylic acid soaps, and combinations thereof.

56. The lubricant of claim 52 wherein the oil is selected from the group consisting of H1, H2, H3, H4, H5, H6, H7, and combinations thereof.

57. An expandable tubular member comprising:
a tubular member comprising an inner surface;
a dry film lubricant coupled to the inner surface; and
a plurality of microcapsules dispersed through the dry film lubricant and each comprising a semi-hard shelled material containing an oil, the semi-hard shelled material operable to open under pressure and release the oil.

58. The expandable tubular member of claim 57 wherein the dry film lubricant is operable to reduce friction on the inner surface while holding the plurality of microcapsules adjacent the inner surface.

59. The expandable tubular member of claim 57 further comprising:
an expansion device positioned in the tubular member and adjacent the inner surface, the expansion device operable to open the semi-hard shelled material to provide the lubricating material between the expansion device and the inner surface while the expansion device expands the tubular member.

60. The expandable tubular member of claim 57 wherein the tubular member is positioned in a well bore.

61. The expandable tubular member of claim 57 wherein the tubular member is a wellbore casing.

62. The expandable tubular member of claim 57 wherein the tubular member is a structural support.

63. The expandable tubular member of claim 57 wherein the tubular member is a pipeline.

64. The expandable tubular member of claim 57 wherein the dry film lubricant comprises 20%-26% Methyl Ethyl Ketone, 20%-25% Titanium dioxide, 4-15% Polytetraflouro ethylene, 40-50% Alkyd Resin CAS, and combinations thereof.

65. The expandable tubular member of claim 57 wherein the oil comprises 64.25-90.89% base oil, 0.02-0.05% metal deactivator, 0.5-3.0% antioxidants, 4-12%, sulfurized natural oils, 4-12% phosphate ester, 0.4-1.5% phosphoric acid, 0.08-1.5% viscosity modifier, 0.1-0.5% pour-point depressant, 0.01-0.2% defoamer, 0-5% carboxylic acid soaps, and combinations thereof.

66. The expandable tubular member of claim 57 wherein the oil is selected from the group consisting of H1, H2, H3, H4, H5, H6, H7, and combinations thereof.

67. An expandable tubular member comprising:
a tubular member comprising an inner surface;
means for reducing friction on the inner surface coupled to the inner surface; and
means for selectively releasing a lubricating material in the means for reducing friction on the inner surface.

68. The expandable tubular member of claim 67 further comprising:
means for expanding the tubular member and for initiating the release of the lubricating material from the means for selectively releasing a lubricating material, the means for expanding positioned in the tubular member and adjacent the inner surface.

69. The expandable tubular member of claim 67 wherein the tubular member is positioned in a well bore.

70. The expandable tubular member of claim 67 wherein the means for reducing friction comprises 20%-26% Methyl Ethyl Ketone, 20%-25% Titanium dioxide, 4-15% Polytetraflouro ethylene, 40-50% Alkyd Resin CAS, and combinations thereof.

71. The expandable tubular member of claim 67 wherein the lubricating material comprises 64.25-90.89% base oil, 0.02-0.05% metal deactivator, 0.5-3.0% antioxidants, 4-12%, sulfurized natural oils, 4-12% phosphate ester, 0.4-1.5% phosphoric acid, 0.08-1.5% viscosity modifier, 0.1-0.5% pour-point depressant, 0.01-0.2% defoamer, 0-5% carboxylic acid soaps, and combinations thereof.

72. The expandable tubular member of claim 67 wherein the lubricating material is selected from the group consisting of H1, H2, H3, H4, H5, H6, H7, and combinations thereof.

73. A method for expanding an expandable tubular member comprising:
providing a tubular member comprising an inner surface;
applying a film of lubricant that dries to the inner surface, the film of lubricant comprising a plurality of microcapsules, the plurality of microcapsules each comprising a semi-hard shelled material containing an oil;
positioning the tubular member in a well bore;
expanding the tubular member by moving an expansion device through the tubular member;
opening the semi-hard shelled material to release the oil between the expansion device and the inner surface as the expansion device moves through the tubular member.
